(19) United States
(12) Patent Application Publication
(10) Pub. No.: US 2025/0380299 A1
(43) Pub. Date: Dec. 11, 2025

(54) COMBATTING REPEATER ATTACKS IN RADIO FREQUENCY (RF) SENSING USING A NETWORK OF SENSING ENTITIES

(71) Applicant: QUALCOMM Incorporated, San Diego, CA (US)

(72) Inventors: Danlu ZHANG, San Diego, CA (US); Weimin DUAN, San Diego, CA (US); Kangqi LIU, San Diego, CA (US)

(21) Appl. No.: 18/740,334

(22) Filed: Jun. 11, 2024

(51) Int. Cl. H04W 74/0808; H04W 12/122; H04W 24/10; H04W 64/00

(52) U.S. Cl. CPC H04W 74/0808; H04W 12/122; H04W 24/10; H04W 64/00

(57) ABSTRACT

Techniques are described for combatting repeater attacks. For example, a network entity can receive information associated with a sensing signal that is transmitted by a network device, interacts with a target object, and received by network devices. The information can include time of arrival (TOA) measurements and angle of arrival (AOA) measurements by the network devices associated with the sensing signal after interaction with the target object. The network entity can determine distance measurements associated with the sensing signal after interaction with the target object based on the TOA measurements. The network entity can apply first weights to the plurality of distance measurements to produce weighted distance measurements and can apply second weights to the plurality of AOA measurements to produce weighted AOA measurements. The network entity can determine an estimated location of the target object and can determine an error in the estimated location of the target object.

### FIELD

The present disclosure generally relates to wireless communications and sensing. For example, aspects of the present disclosure relate to combatting repeater attacks in radio frequency (RF) sensing using a network of sensing entities.

### BACKGROUND

Increasingly, systems and devices (e.g., autonomous vehicles, such as autonomous and semi-autonomous cars, drones, mobile robots, mobile devices, cellular base stations, extended reality (XR) devices, and other suitable systems or devices) include multiple sensors to gather information about the environment, as well as processing systems to process the information gathered, such as for route planning, navigation, collision avoidance, etc. Sensor data, such as RF sensor data captured from one or more radar sensors, may be gathered, transformed, and analyzed to detect objects. Securing sensor data, such as securing RF sensor data against jamming, for devices is important to ensure data integrity and prevent spoofer attacks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for combatting repeater attacks in RF sensing using a network of sensing entities.

In some aspects, a network entity for wireless communications is provided. The network entity includes at least one memory and at least one processor coupled to the at least one memory and configured to: receive information associated with a sensing signal, wherein the sensing signal is transmitted by a network device, interacts with a target object, and is received by a plurality of network devices, wherein the information includes a plurality of time of arrival (TOA) measurements and a plurality of angle of arrival (AOA) measurements by the plurality of network devices associated with the sensing signal after interaction with the target object; determine a plurality of distance measurements associated with the sensing signal after interaction with the target object based on the plurality of TOA measurements; apply first weights to the plurality of distance measurements to produce a plurality of weighted distance measurements; apply second weights to the plurality of AOA measurements to produce a plurality of weighted AOA measurements; determine an estimated location of the target object based on at least a subset of the plurality of weighted distance measurements and at least a subset of the plurality of weighted AOA measurements after interaction with the target object; and determine an error in the estimated location of the target object based on the plurality of weighted distance measurements and the plurality of weighted AOA measurements after interaction with the target object.

In some aspects, a method for wireless communications at a network entity is provided. The method includes: receiving, by the network entity, information associated with a sensing signal, wherein the sensing signal is transmitted by a network device, interacts with a target object, and is received by a plurality of network devices, wherein the information includes a plurality of time of arrival (TOA) measurements and a plurality of angle of arrival (AOA) measurements by the plurality of network devices associated with the sensing signal after interaction with the target object; determining, by the network entity, a plurality of distance measurements associated with the sensing signal after interaction with the target object based on the plurality of TOA measurements; applying, by the network entity, first weights to the plurality of distance measurements to a plurality of produce weighted distance measurements; applying, by the network entity, second weights to the plurality of AOA measurements to produce a plurality of weighted AOA measurements; determining, by the network entity, an estimated location of the target object based on at least a subset of the plurality of weighted distance measurements and at least a subset of the plurality of weighted AOA measurements after interaction with the target object; and determining, by the network entity, an error in the estimated location of the target object based on the plurality of weighted distance measurements and the plurality of weighted AOA measurements after interaction with the target object.

In another example, a non-transitory computer-readable medium is provided that has stored thereon instructions that, when executed by one or more processors, cause the one or more processors to: receive information associated with a sensing signal, wherein the sensing signal is transmitted by a network device, interacts with a target object, and is received by a plurality of network devices, wherein the information includes a plurality of time of arrival (TOA) measurements and a plurality of angle of arrival (AOA) measurements by the plurality of network devices associated with the sensing signal after interaction with the target object; determine a plurality of distance measurements associated with the sensing signal after interaction with the target object based on the plurality of TOA measurements; apply first weights to the plurality of distance measurements to produce a plurality of weighted distance measurements; apply second weights to the plurality of AOA measurements to produce a plurality of weighted AOA measurements; determine an estimated location of the target object based on at least a subset of the plurality of weighted distance measurements and at least a subset of the plurality of weighted AOA measurements after interaction with the target object; and determine an error in the estimated location of the target object based on the plurality of weighted distance measurements and the plurality of weighted AOA measurements after interaction with the target object.

In another example, an apparatus for wireless communications is provided. The apparatus includes: means for receiving information associated with a sensing signal, wherein the sensing signal is transmitted by a network device, interacts with a target object, and is received by a plurality of network devices, wherein the information includes a plurality of time of arrival (TOA) measurements and a plurality of angle of arrival (AOA) measurements by the plurality of network devices associated with the sensing signal after interaction with the target object; means for determining a plurality of distance measurements associated with the sensing signal after interaction with the target object based on the plurality of TOA measurements; means for applying first weights to the plurality of distance measurements to produce a plurality of weighted distance measurements; means for applying second weights to the plurality of AOA measurements to produce a plurality of weighted AOA measurements; means for determining an estimated location of the target object based on at least a subset of the plurality of weighted distance measurements and at least a subset of the plurality of weighted AOA measurements after interaction with the target object; and means for determining an error in the estimated location of the target object based on the plurality of weighted distance measurements and the plurality of weighted AOA measurements after interaction with the target object.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wireless communication device, a cellular base station, a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example wireless communications system, which may be employed by the disclosed systems and techniques, in accordance with some aspects of the present disclosure.

FIG. 2 is a diagram illustrating an example of a disaggregated base station architecture, which may be employed by the disclosed systems and techniques, in accordance with some aspects of the present disclosure.

FIG. 3 is a diagram illustrating an example of a frame structure, which may be employed by the disclosed systems and techniques, in accordance with some aspects of the present disclosure.

FIG. 4 is a block diagram illustrating an example of a computing system of an electronic device that may be employed by the disclosed systems and techniques, in accordance with some aspects of the present disclosure.

FIG. 5 is a diagram illustrating an example of a wireless device utilizing RF monostatic sensing techniques, which may be employed by the disclosed systems and techniques described herein to determine one or more characteristics of a target object, in accordance with some aspects of the present disclosure.

FIG. 6 is a diagram illustrating an example of a receiver utilizing RF bistatic sensing techniques with one transmitter, which may be employed by the disclosed systems and techniques described herein to determine one or more characteristics of a target object, in accordance with some aspects of the present disclosure.

FIG. 7 is a diagram illustrating an example of a receiver utilizing RF bistatic sensing techniques with multiple transmitters, which may be employed by the disclosed systems and techniques described herein to determine one or more characteristics of a target object, in accordance with some aspects of the present disclosure.

FIG. 8 is a diagram illustrating an example geometry for bistatic (or monostatic) sensing, in accordance with some aspects of the present disclosure.

FIG. 9 is a diagram illustrating a bistatic range of bistatic sensing, in accordance with some aspects of the present disclosure.

FIG. 10 is a diagram illustrating an example of a system utilizing RF multi-static sensing techniques with one transmitter and multiple receivers, which may be employed by the disclosed systems and techniques described herein to determine one or more characteristics of a target object, in accordance with some aspects of the present disclosure.

FIG. 11 is a diagram illustrating examples of geometric dilution of precision (GDOP) scenarios where time of arrival (TOA) measurements are used for positioning, angle of arrival (AOA) measurements are used for positioning, and a combination of TOA and AOA measurements are used for positioning, in accordance with some aspects of the present disclosure.

FIG. 12 is a graph illustrating an example of three dimensional (3D) geometry utilized for positioning, in accordance with some aspects of the present disclosure.

FIG. 13 is a flow diagram illustrating an example of a process for wireless communications, in accordance with aspects of the present disclosure.

FIG. 14 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

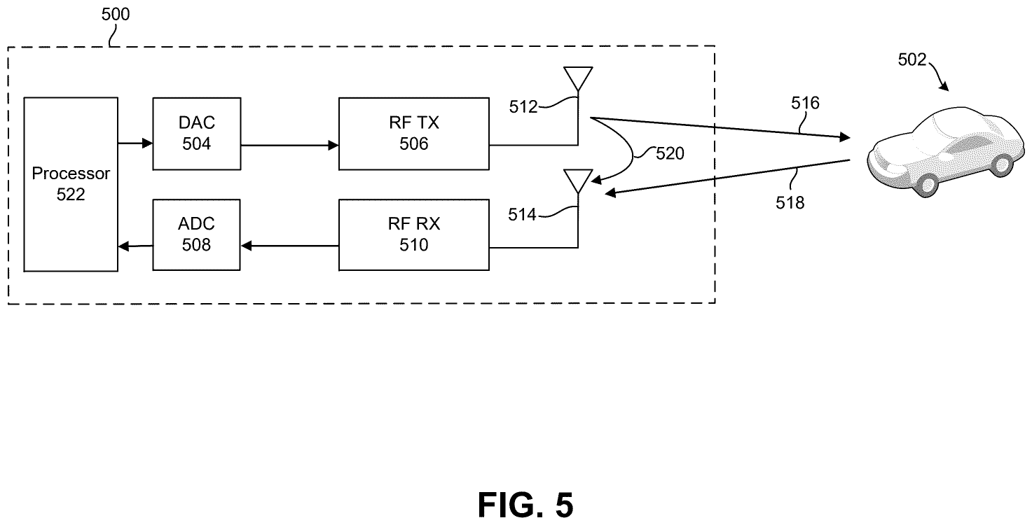

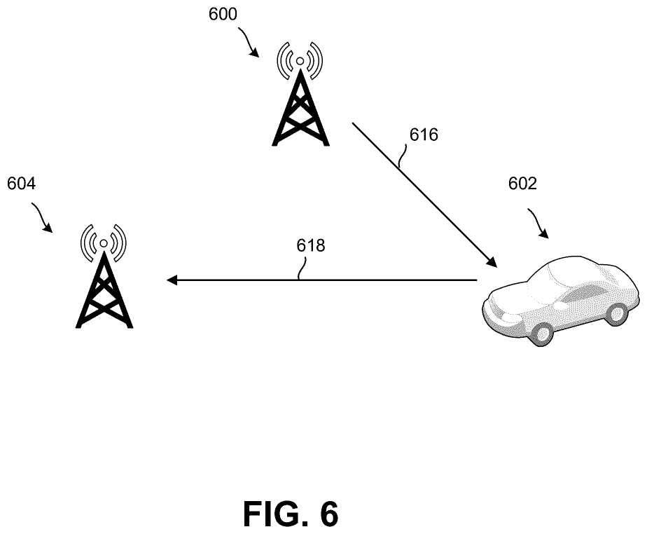

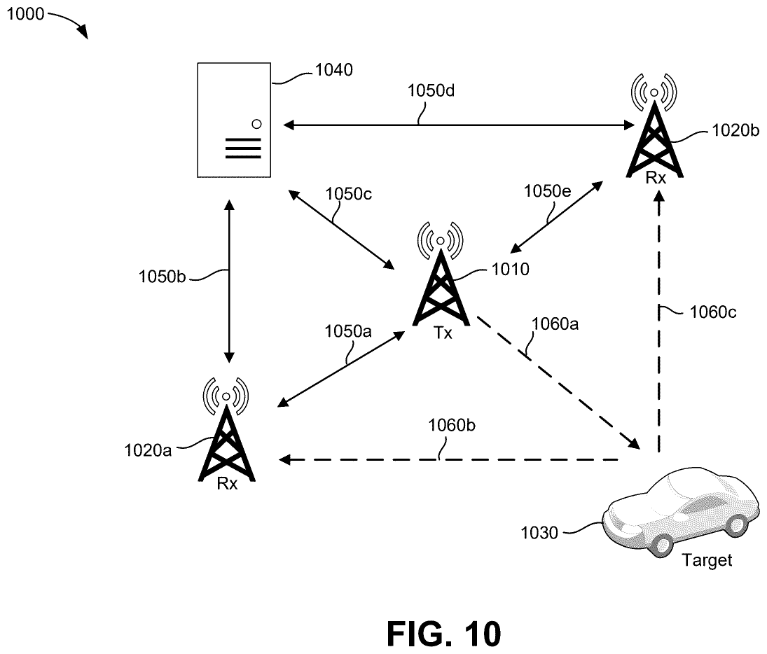

Radar sensing systems use radio frequency (RF) waveforms to perform RF sensing to determine or estimate one or more characteristics of a target object, such as the distance, angle, and/or velocity of the target object. A target object may include a vehicle, an obstruction, a user, a building, or other object. A typical radar system includes at least one transmitter, at least one receiver, and at least one processor. A radar sensing system may perform monostatic sensing (e.g., as shown in FIG. 5) when one receiver is employed that is co-located with a transmitter. A radar system may perform bistatic sensing (e.g., as shown in FIG. 6) when one receiver of a first device is employed that is located remote from a transmitter of a second device. Similarly, a radar system may perform multi-static sensing (e.g., as shown in FIG. 10) when multiple receivers of multiple devices are employed that are all located remotely from at least one transmitter of at least one device.

During operation of a radar sensing system, a transmitter can transmit an electromagnetic (EM) signal in the RF domain towards a target object. The signal can reflect off of the target object to produce one or more reflection signals, which can provide information or properties regarding the target, such as target object's location and speed. At least one receiver can receive the one or more reflection signals and at least one processor, which may be associated with at least one receiver, can utilize the information from the one or more reflection signals to determine information or properties of the target object. A target object can also be referred herein as a target.

Generally, RF sensing involves monitoring moving targets with different motions (e.g., a moving car or pedestrian, a body motion of a person, such as breathing, and/or other micro-motions related to a target). Doppler, which measures the phase variation in a signal and is indicative of motion, is an important characteristic for sensing of a target.

In some cases, the radar sensing signals, which can be referred to as radar reference signals (RSs), may be designed for and used for sensing purposes. Radar RSs generally do not contain any communications information. Conversely, communication RSs, such as demodulation reference signals (DMRSs) and sounding reference signals (SRSs), are typically designed for and solely used for communications purposes, such as estimating channel parameters for communications.

Cellular communications systems are designed to transmit communication signals on designated communication frequency bands (e.g., 23 gigahertz (GHz), 3.5 GHZ, etc. for 5G/NR, 2.2 GHz for LTE, among others) between two or more transceivers (e.g., cooperative transceivers). RF sensing systems are designed to transmit RF sensing signals on designated radar RF frequency bands (e.g., 77 GHz for autonomous driving) towards targets (e.g., which may be an uncooperative targets).

As previously mentioned, increasingly, systems and devices (e.g., autonomous vehicles, such as autonomous and semi-autonomous cars, drones, mobile robots, mobile devices, cellular base stations, XR devices, and other suitable systems or devices) include multiple sensors (e.g., camera sensors, radar sensors, and/or light detection and ranging (LIDAR) sensors) to gather information about the environment, as well as processing systems to process the information gathered, such as for route planning, navigation, collision avoidance, etc. Sensor data, such as RF sensor data captured from one or more radar sensors, may be gathered, transformed, and analyzed to detect objects. Securing sensor data (e.g., securing RF sensor data against jamming) for devices is important to ensure data integrity and prevent spoofer attacks.

Currently, RF sensing is one potentially important area for sixth generation (6G) technology. RF sensing can be employed for object detection for various different use cases including, but not limited to, vehicle (e.g., terrestrial vehicle) detection and unmanned aerial vehicle (UAV) detection. Security is vital for 6G and, as such, security in RF sensing should be carefully considered. RF sensing is vulnerable to spoofer attacks (e.g., susceptible to jamming attacks) because the reflected signals received in RF sensing are weak (e.g., have a low signal strength), due to the reflected signals being reflected non-line-of-sight (NLOS) signals. As such, the signal to noise ratio (SNR) of the received reflected signals is typically lower than the SNR for communications signals, which are typically non-reflected line of sight (LOS) signals.

One type of jamming attack is a repeater attack, where a jammer (e.g., a spoofer) intercepts a transmitted sensing signal, and replays the sensing signal with a certain delay and propagates the sensing signal at a certain direction. Repeater attacks can be problematic for traditional radar systems (e.g., utilizing only a single transmitter and a single receiver), and can be difficult to defend against.

As such, improved systems and techniques for combatting repeater attacks in RF sensing can be beneficial.

In one or more aspects, systems, apparatuses, processes (also referred to as methods), and computer-readable media (collectively referred to herein as “systems and techniques”) are described herein for combatting repeater attacks in RF sensing using a network of sensing entities. In one or more examples, the systems and techniques can combat repeater attacks by providing jamming detection and anti-jamming measures. In some examples, the range of measures can depend upon the jammer capability. In some examples, the system and techniques employ a network of sensing entities (e.g., radar receivers), which can be distinguished from traditional radar systems utilizing only a single transmitter and a single receiver, to combat jamming in the form of repeater attacks. The term “sensing entity” may refer to any type of sensing entity, such as a base station, user equipment (UE), or a controlled repeater. In one or more examples, the systems and techniques provide privacy protection against unwanted sensing, which can allow for legitimate use cases for jamming techniques.

In one or more aspects, during operation of the systems and techniques for wireless communications, a network entity can receive information associated with a sensing signal. For example, the sensing signal is transmitted by a network device, interacts with a target object (e.g., by reflecting off of the target object or by being manipulated by the target object, such as by manipulating the Doppler in the signal), and is received by a plurality of network devices. In some cases, the information includes a plurality of time of arrival (TOA) measurements and a plurality of angle of arrival (AOA) measurements by the plurality of network devices associated with the sensing signal after interaction with the target object. The network entity can determine a plurality of distance measurements associated with the sensing signal after interaction with the target object based on the plurality of TOA measurements. The network entity can apply first weights to the plurality of distance measurements to produce a plurality of weighted distance measurements and can apply second weights to the plurality of AOA measurements to produce a plurality of weighted AOA measurements. The network entity can determine an estimated location of the target object based on at least a subset of the plurality of weighted distance measurements and at least a subset of the plurality of weighted AOA measurements after interaction with the target object. In some cases, the interaction with the target object may include a reflection of the sensing signal from the target object or an active manipulation of the sensing signal by the target object. The network entity can determine an error in the estimated location of the target object based on the plurality of weighted distance measurements and the plurality of weighted AOA measurements after interaction with the target object.

In one or more examples, the network entity can further determine a jamming scenario is present based on the error in the estimated location of the target object being greater than an error threshold. In some examples, the network entity can track the target object over a period of time to observe a velocity of the target object and a Doppler of the target object. In one or more examples, the network entity can determine a jamming scenario is present based on determining a discrepancy between the velocity of the target object and the Doppler of the target object over the period of time.

In some examples, the network entity can further determine a jamming scenario is present based on determining a discrepancy in the plurality of AOA measurements. In one or more examples, the network entity can determine a jamming scenario is present based on a discrepancy in the plurality of distance measurements.

In one or more examples, the transmit sensing signal can include multiple frequencies. In some examples, the transmit sensing signal can include a pulse with suppressed ripples. In one or more examples, the pulse with suppressed ripples can be a Gaussian pulse.

In some examples, the transmit sensing signal can be encoded with a code with an auto-correlation function. In one or more examples, the code can be a Zadoff-Chu code. In some examples, a phase of the code can be randomized.

In one or more examples, the first weights and the second weights can be based on a signal to noise ratio (SNR) of the sensing signal after interaction with the target object, an accuracy of the plurality of TOA measurements, and/or an accuracy of the plurality of AOA measurements.

In some examples, the network entity can be a sensing function. In one or more examples, the sensing function can be implemented in a sensing server and/or in a network device of the plurality of network devices. In some examples, the network device of the plurality of network devices can be a receiver device. In one or more examples, the network device of the plurality of network devices and at least one other network device of the plurality of network devices can be separated spatially from each other around the target object. In some examples, the network device that transmits the sensing signal can be a transmitter device. In one or more examples, the network device of the plurality of network devices can be located at a known first position, and the network device that transmits the sensing signal can be located at a known second position.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical Transmission-Reception Point (TRP) or to multiple physical Transmission-Reception Points (TRPs) that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal includes an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

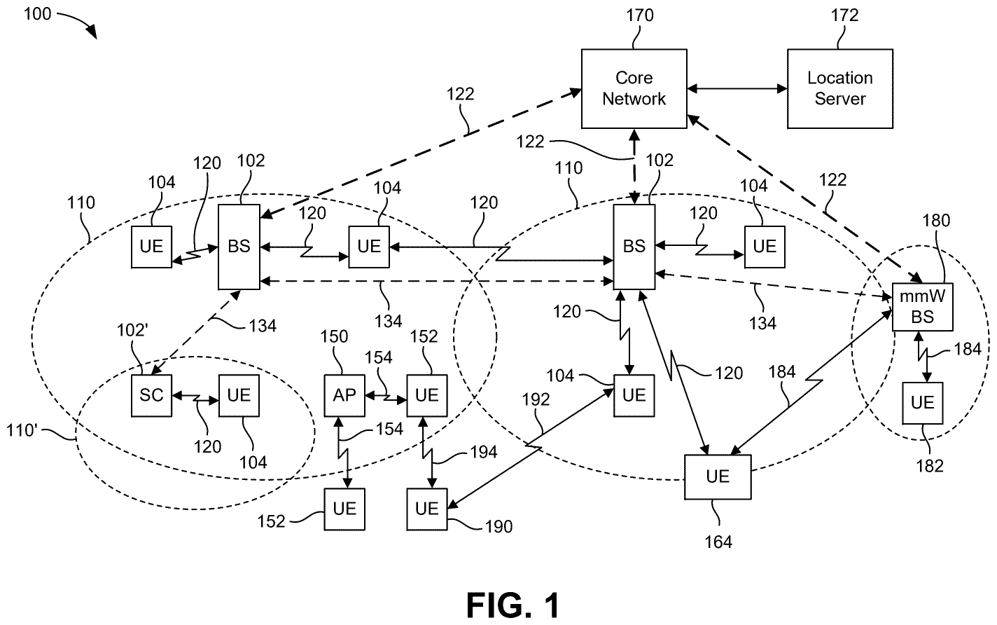

According to various aspects, FIG. 1 illustrates an exemplary wireless communications system 100, which may be employed by the disclosed systems and techniques described herein. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on. As noted above, UE 104 and UE 190 can be configured to communicate using sidelink communications. In some cases, a sidelink transmission can include a request for feedback (e.g., a hybrid automatic repeat request (HARQ)) from the receiving UE.

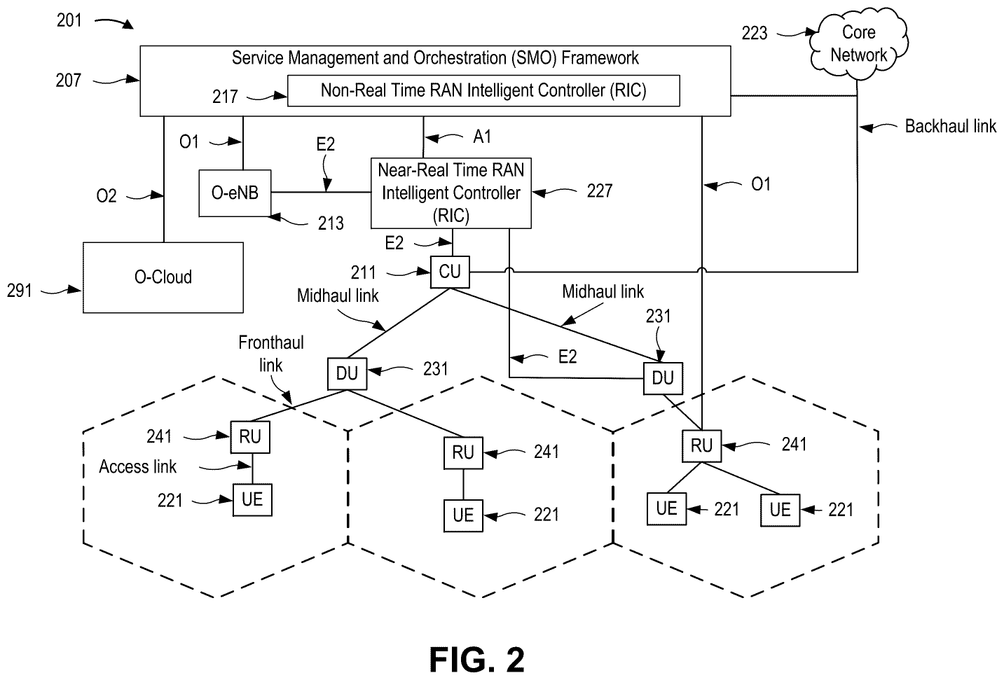

FIG. 2 is a diagram illustrating an example of a disaggregated base station architecture, which may be employed by the disclosed systems and techniques. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 201 architecture. The disaggregated base station 201 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) 231 via respective midhaul links, such as an F1 interface. The DUs 231 may communicate with one or more radio units (RUs) 241 via respective fronthaul links. The RUs 241 may communicate with respective UEs 221 via one or more RF access links. In some implementations, the UE 221 may be simultaneously served by multiple RUs 241.

Each of the units, i.e., the CUS 211, the DUs 231, the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (i.e., Central Unit-User Plane (CU-UP)), control plane functionality (i.e., Central Unit-Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the E1 interface when implemented in an O-RAN configuration. The CU 211 can be implemented to communicate with the DU 231, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

Lower-layer functionality can be implemented by one or more RUs 241. In some deployments, an RU 241, controlled by a DU 231, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a cloud-based RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs 211, DUs 231, RUs 241 and Near-RT RICs 227. In some implementations, the SMO Framework 207 can communicate with a hardware aspect of a 4G RAN, such as an open eNB (O-eNB) 213, via an O1 interface. Additionally, in some implementations, the SMO Framework 207 can communicate directly with one or more RUs 241 via an O1 interface. The SMO Framework 207 also may include a Non-RT RIC 217 configured to support functionality of the SMO Framework 207.

The Non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 217 may be coupled to or communicate with (such as via an A1 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs 211, one or more DUs 231, or both, as well as an O-eNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the Non-RT RIC 217 or the Near-RT RIC 227 may be configured to tune RAN behavior or performance. For example, the Non-RT RIC 217 may monitor long-term trends and patterns for performance and employ AI/ML models to perform corrective actions through the SMO Framework 207 (such as reconfiguration via O1) or via creation of RAN management policies (such as A1 policies).

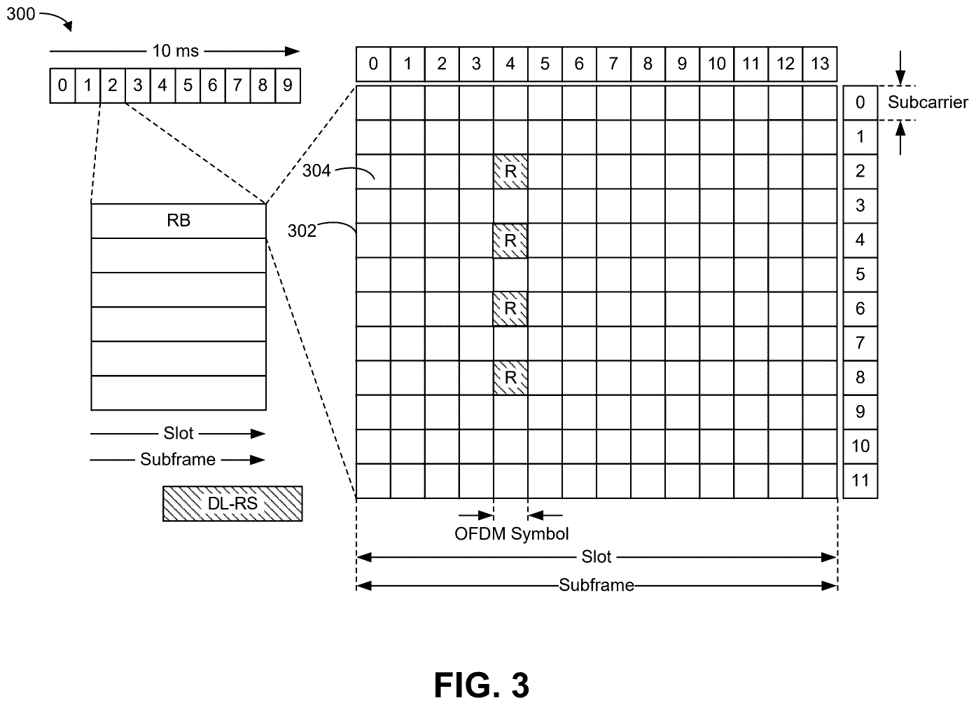

Various radio frame structures may be used to support downlink, uplink, and sidelink transmissions between network nodes (e.g., base stations and UEs). FIG. 3 is a diagram 300 illustrating an example of a frame structure, which may be employed by the disclosed systems and techniques. Other wireless communications technologies may have different frame structures and/or different channels.

NR (and LTE) utilizes orthogonal frequency division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHZ, respectively.

LTE supports a single numerology (subcarrier spacing, symbol length, etc.). In contrast, NR may support multiple numerologies (μ). For example, subcarrier spacing (SCS) of 15 kHz, 30 kHz, 60 kHz, 120 kHz, and 240 kHz or greater may be available. Table 1 provided below lists some various parameters for different NR numerologies.

TABLE 1

| | | | | | | | Max. nominal |
|---|---|---|---|---|---|---|---|
| | | | | | Slot | Symbol | system BW |
| | SCS | Symbols/ | Slots/ | Slots/ | Duration | Duration | (MHz) with |
| | (kHz) | Sot | Subframe | Frame | (ms) | (μs) | 4K FFT size |
| 0 | 15 | 14 | 1 | 10 | 1 | 66.7 | 50 |
| 1 | 30 | 14 | 2 | 20 | 0.5 | 33.3 | 100 |
| 2 | 60 | 14 | 4 | 40 | 0.25 | 16.7 | 100 |
| 3 | 120 | 14 | 8 | 80 | 0.125 | 8.33 | 400 |
| 4 | 240 | 14 | 16 | 160 | 0.0625 | 4.17 | 800 |

In one example, a numerology of 15 kHz is used. Thus, in the time domain, a 10 millisecond (ms) frame is divided into 10 equally sized subframes of 1 ms each, and each subframe includes one time slot. In FIG. 3, time is represented horizontally (e.g., on the X axis) with time increasing from left to right, while frequency is represented vertically (e.g., on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. FIG. 3 illustrates an example of a resource block (RB) 302. Data or information for joint communications and sensing may be included in one or more RBs 302. The RB 302 is arranged with the time domain on the horizontal (or x-) axis and the frequency domain on the vertical (or y-) axis. As shown, the RB 302 may be 180 kilohertz (kHz) wide in frequency and one slot long in time (with a slot being 1 milliseconds (ms) in time). In some cases, the slot may include fourteen symbols (e.g., in a slot configuration 0). The RB 302 includes twelve subcarriers (along the y-axis) and fourteen symbols (along the x-axis).

An intersection of a symbol and subcarrier can be referred to as a resource element (RE) 304 or tone. The RB 302 of FIG. 3 includes multiple REs, including the resource element (RE) 304. For instance, a RE 304 is 1 subcarrier x 1 symbol (e.g., OFDM symbol), and is the smallest discrete part of the subframe. A RE 304 includes a single complex value representing data from a physical channel or signal. The number of bits carried by each RE 304 depends on the modulation scheme.

In some aspects, some REs 304 can be used to transmit downlink reference (pilot) signals (DL-RS). The DL-RS can include Positioning Reference Signal (PRS), Tracking Reference Signal (TRS), Phase Tracking Reference Signal (PTRS), Channel State Information Reference Signal (CSI-RS), Demodulation Reference Signal (DMRS), Primary Synchronization Signal (PSS), Secondary Synchronization Signal (SSS), etc. The resource grid if FIG. 3 illustrates exemplary locations of REs 304 used to transmit DL-RS (labeled “R”).

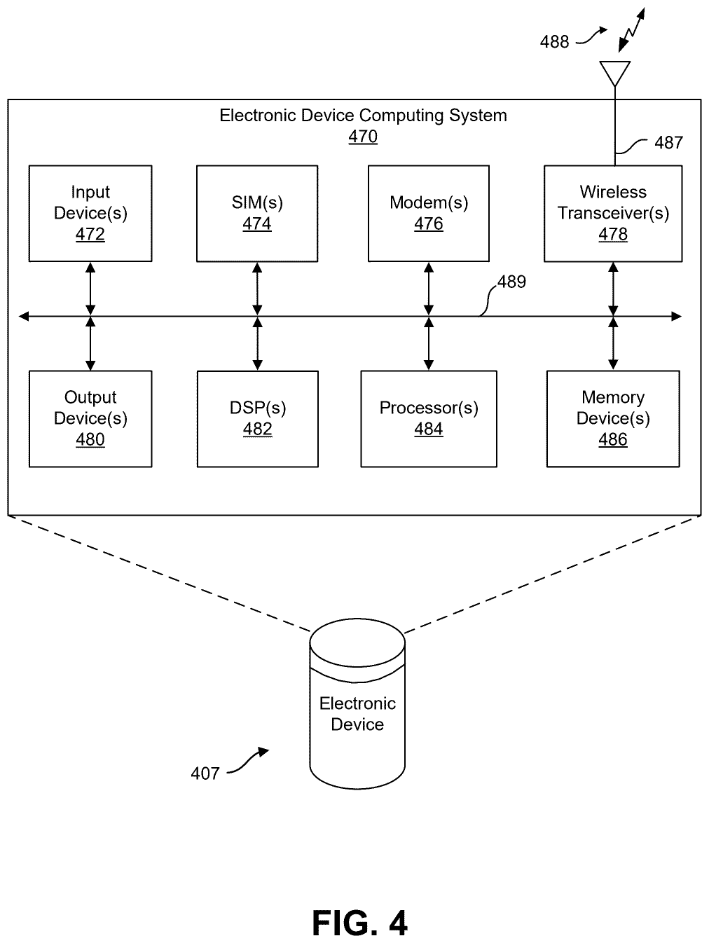

FIG. 4 is a block diagram illustrating an example of a computing system 470 of an electronic device 407, which may be employed by the disclosed systems and techniques. The electronic device 407 is an example of a device that can include hardware and software for the purpose of connecting and exchanging data with other devices and systems using a communications network (e.g., a 3^{rd} Generation Partnership network, such as a 5^{th} Generation (5G)/New Radio (NR) network, a 4^{th} Generation (4G)/Long Term Evolution (LTE) network, a WiFi network, or other communications network). For example, the electronic device 407 can include, or be a part of, a mobile device (e.g., a mobile telephone), a wearable device (e.g., a network-connected or smart watch), an extended reality device (e.g., a virtual reality (VR) device, an augmented reality (AR) device, or a mixed reality (MR) device), a personal computer, a laptop computer, a tablet computer, an Internet-of-Things (IoT) device, a wireless access point, a router, a vehicle or component of a vehicle, a server computer, a robotics device, and/or other device used by a user to communicate over a wireless communications network. In some cases, the device 407 can be referred to as user equipment (UE), such as when referring to a device configured to communicate using 5G/NR, 4G/LTE, or other telecommunication standard. In some cases, the device can be referred to as a station (STA), such as when referring to a device configured to communicate using the Wi-Fi standard.

The computing system 470 includes software and hardware components that can be electrically or communicatively coupled via a bus 489 (or may otherwise be in communication, as appropriate). For example, the computing system 470 includes one or more processors 484. The one or more processors 484 can include one or more CPUs, ASICs, FPGAs, APs, GPUs, VPUs, NSPs, microcontrollers, dedicated hardware, any combination thereof, and/or other processing device/s and/or system/s. The bus 489 can be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone or a microphone array, and/or the like), and one or more output devices 480 (e.g., a display, a speaker, a printer, and/or the like).

The one or more wireless transceivers 478 can receive wireless signals (e.g., signal 488) via antenna 487 from one or more other devices, such as other user devices, network devices (e.g., base stations such as evolved Node Bs (eNBs) and/or gNodeBs (gNBs), WiFi access points (APs) such as routers, range extenders or the like, etc.), cloud networks, and/or the like. In some examples, the computing system 470 can include multiple antennas or an antenna array that can facilitate simultaneous transmit and receive functionality. Antenna 487 can be an omnidirectional antenna such that RF signals can be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 488 into a baseband or intermediate frequency and can convert the RF signals to the digital domain.

In some cases, the computing system 470 can include a coding-decoding device (or CODEC) configured to encode and/or decode data transmitted and/or received using the one or more wireless transceivers 478. In some cases, the computing system 470 can include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 478.

The one or more SIMs 474 can each securely store an international mobile subscriber identity (IMSI) number and related key assigned to the user of the electronic device 407. The IMSI and key can be used to identify and authenticate the subscriber when accessing a network provided by a network service provider or operator associated with the one or more SIMs 474. The one or more modems 476 can modulate one or more signals to encode information for transmission using the one or more wireless transceivers 478. The one or more modems 476 can also demodulate signals received by the one or more wireless transceivers 478 in order to decode the transmitted information. In some examples, the one or more modems 476 can include a WiFi modem, a 4G (or LTE) modem, a 5G (or NR) modem, and/or other types of modems. The one or more modems 476 and the one or more wireless transceivers 478 can be used for communicating data for the one or more SIMs 474.

The computing system 470 can also include (and/or be in communication with) one or more non-transitory machine-readable storage media or storage devices (e.g., one or more memory devices 486), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 can also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

In some aspects, the electronic device 407 can include means for performing operations described herein. The means can include one or more of the components of the computing system 470. For example, the means for performing operations described herein may include one or more of input device(s) 472, SIM(s) 474, modems(s) 476, wireless transceiver(s) 478, output device(s) 480, DSP(s) 482, processors 484, memory device(s) 486, and/or antenna(s) 487.

In some aspects, the electronic device 407 can include means for providing joint communications and sensing as well as a means for utilizing sensing signals for both sensing and demodulating communications signals. In some examples, any or all of these means can include the one or more wireless transceivers 478, the one or more modems 476, the one or more processors 484, the one or more DSPs 482, the one or more memory devices 486, any combination thereof, or other component(s) of the electronic device 407.

FIG. 5 is a diagram illustrating an example of a wireless device 500 utilizing RF monostatic sensing technique for determining one or more characteristics (e.g., location, speed or velocity, heading, etc.) of a target 502 object. In particular, FIG. 5 is a diagram illustrating an example of a wireless device 500 (e.g., a transmit/receive sensing node) that utilizes RF sensing techniques (e.g., monostatic sensing) to perform one or more functions, such as detecting a presence and location of a target 502 (e.g., an object, user, or vehicle), which in this figure is illustrated in the form of a vehicle.

In some examples, the wireless device 500 can be a mobile phone, a tablet computer, a wearable device, a vehicle, an extending reality (XR) device, a computing device or component of a vehicle, or other device (e.g., device 407 of FIG. 4) that includes at least one RF interface. In some examples, the wireless device 500 can be a device that provides connectivity for a user device (e.g., for electronic device 407 of FIG. 4), such as a base station (e.g., a gNB, eNB, etc.), a wireless access point (AP), or other device that includes at least one RF interface.

In some aspects, wireless device 500 can include one or more components for transmitting an RF signal. The wireless device 500 can include at least one processor 522 for generating a digital signal or waveform. The wireless device 500 can also include a digital-to-analog converter (DAC) 504 that is capable of receiving the digital signal or waveform from the processor(s) 522 (e.g., a microprocessor), and converting the digital signal or waveform to an analog waveform. The analog signal that is the output of the DAC 504 can be provided to RF transmitter 506 for transmission. The RF transmitter 506 can be a Wi-Fi transmitter, a 5G/NR transmitter, a Bluetooth™ transmitter, or any other transmitter capable of transmitting an RF signal.

RF transmitter 506 can be coupled to one or more transmitting antennas such as Tx antenna 512. In some examples, transmit (Tx) antenna 512 can be an omnidirectional antenna that is capable of transmitting an RF signal in all directions. For example, Tx antenna 512 can be an omnidirectional Wi-Fi antenna that can radiate Wi-Fi signals (e.g., 2.4 GHz, 5 GHZ, 6 GHz, etc.) in a 360-degree radiation pattern. In another example, Tx antenna 512 can be a directional antenna that transmits an RF signal in a particular direction.

In some examples, wireless device 500 can also include one or more components for receiving an RF signal. For example, the receiver lineup in wireless device 500 can include one or more receiving antennas such as a receive (Rx) antenna 514. In some examples, Rx antenna 514 can be an omnidirectional antenna capable of receiving RF signals from multiple directions. In other examples, Rx antenna 514 can be a directional antenna that is configured to receive signals from a particular direction. In further examples, the Tx antenna 512 and/or the Rx antenna 514 can include multiple antennas (e.g., elements) configured as an antenna array (e.g., a phase antenna array), which may be used for MIMO techniques.

Wireless device 500 can also include an RF receiver 510 that is coupled to Rx antenna 514. RF receiver 510 can include one or more hardware components for receiving an RF waveform such as a Wi-Fi signal, a Bluetooth™ signal, a 5G/NR signal, or any other RF signal. The output of RF receiver 510 can be coupled to an analog-to-digital converter (ADC) 508. ADC 508 can be configured to convert the received analog RF waveform into a digital waveform. The digital waveform that is the output of the ADC 508 can be provided to the processor(s) 522 for processing. The processor(s) 522 (e.g., a digital signal processor (DSP)) can be configured for processing the digital waveform.

In one example, wireless device 500 can implement RF sensing techniques, for example monostatic sensing techniques, by causing a Tx waveform 516 to be transmitted from Tx antenna 512. Although Tx waveform 516 is illustrated as a single line, in some cases, Tx waveform 516 can be transmitted in all directions by an omnidirectional Tx antenna 512. In one example, Tx waveform 516 can be a Wi-Fi waveform that is transmitted by a Wi-Fi transmitter in wireless device 500. In some cases, Tx waveform 516 can correspond to a Wi-Fi waveform that is transmitted at or near the same time as a Wi-Fi data communication signal or a Wi-Fi control function signal (e.g., a beacon transmission). In some examples, Tx waveform 516 can be transmitted using the same or a similar frequency resource as a Wi-Fi data communication signal or a Wi-Fi control function signal (e.g., a beacon transmission). In some aspects, Tx waveform 516 can correspond to a Wi-Fi waveform that is transmitted separately from a Wi-Fi data communication signal and/or a Wi-Fi control signal (e.g., Tx waveform 516 can be transmitted at different times and/or using a different frequency resource).

In some examples, Tx waveform 516 can correspond to a 5G NR waveform that is transmitted at or near the same time as a 5G NR data communication signal or a 5G NR control function signal. In some examples, Tx waveform 516 can be transmitted using the same or a similar frequency resource as a 5G NR data communication signal or a 5G NR control function signal. In some aspects, Tx waveform 516 can correspond to a 5G NR waveform that is transmitted separately from a 5G NR data communication signal and/or a 5G NR control signal (e.g., Tx waveform 516 can be transmitted at different times and/or using a different frequency resource).

In some aspects, one or more parameters associated with Tx waveform 516 can be modified that may be used to increase or decrease RF sensing resolution. The parameters may include frequency, bandwidth, number of spatial streams, the number of antennas configured to transmit Tx waveform 516, the number of antennas configured to receive a reflected RF signal (e.g., Rx waveform 518) corresponding to Tx waveform 516, the number of spatial links (e.g., number of spatial streams multiplied by number of antennas configured to receive an RF signal), the sampling rate, or any combination thereof. The transmitted waveform (e.g., Tx waveform 516) and the received waveform (e.g., Rx waveform 518) can include one or more RF sensing signals, which are also referred to as radar reference signals (RSs).

In further examples, Tx waveform 516 can be implemented to have a sequence that has perfect or almost perfect autocorrelation properties. For instance, Tx waveform 516 can include single carrier Zadoff sequences or can include symbols that are similar to orthogonal frequency-division multiplexing (OFDM) Long Training Field (LTF) symbols. In some cases, Tx waveform 516 can include a chirp signal, as used, for example, in a Frequency-Modulated Continuous-Wave (FM-CW) radar system. In some configurations, the chirp signal can include a signal in which the signal frequency increases and/or decreases periodically in a linear and/or an exponential manner.

In some aspects, wireless device 500 can implement RF sensing techniques by performing alternating transmit and receive functions (e.g., performing a half-duplex operation). For example, wireless device 500 can alternately enable its RF transmitter 506 to transmit the Tx waveform 516 when the RF receiver 510 is not enabled to receive (i.e. not receiving), and enable its RF receiver 510 to receive the Rx waveform 518 when the RF transmitter 506 is not enabled to transmit (i.e. not transmitting). When the wireless device 500 is performing a half-duplex operation, the wireless device 500 may transmit Tx waveform 516, which may be a radar RS (e.g., sensing signal).

In other aspects, wireless device 500 can implement RF sensing techniques by performing concurrent transmit and receive functions (e.g., performing a sub-band or full-band full-duplex operation). For example, wireless device 500 can enable its RF receiver 510 to receive at or near the same time as it enables RF transmitter 506 to transmit Tx waveform 516. When the wireless device 500 is performing a full-duplex operation (e.g., either sub-band full-duplex or full-band full-duplex), the wireless device 500 may transmit Tx waveform 516, which may be a radar RS (e.g., sensing signal).

In some examples, transmission of a sequence or pattern that is included in Tx waveform 516 can be repeated continuously such that the sequence is transmitted a certain number of times or for a certain duration of time. In some examples, repeating a pattern in the transmission of Tx waveform 516 can be used to avoid missing the reception of any reflected signals if RF receiver 510 is enabled after RF transmitter 506. In one example implementation, Tx waveform 516 can include a sequence having a sequence length L that is transmitted two or more times, which can allow RF receiver 510 to be enabled at a time less than or equal to L in order to receive reflections corresponding to the entire sequence without missing any information.

By implementing alternating or simultaneous transmit and receive functionality (e.g. half-duplex or full-duplex operation), wireless device 500 can receive signals that correspond to Tx waveform 516. For example, wireless device 500 can receive signals that are reflected from objects or people that are within range of Tx waveform 516, such as Rx waveform 518 reflected from target 502. Wireless device 500 can also receive leakage signals (e.g., Tx leakage signal 520) that are coupled directly from Tx antenna 512 to Rx antenna 514 without reflecting from any objects. For example, leakage signals can include signals that are transferred from a transmitter antenna (e.g., Tx antenna 512) on a wireless device to a receive antenna (e.g., Rx antenna 514) on the wireless device without reflecting from any objects. In some cases, Rx waveform 518 can include multiple sequences that correspond to multiple copies of a sequence that are included in Tx waveform 516. In some examples, wireless device 500 can combine the multiple sequences that are received by RF receiver 510 to improve the signal to noise ratio (SNR).

Wireless device 500 can further implement RF sensing techniques by obtaining RF sensing data associated with each of the received signals corresponding to Tx waveform 516. In some examples, the RF sensing data can include channel state information (CSI) data relating to the direct paths (e.g., leakage signal 520) of Tx waveform 516 together with data relating to the reflected paths (e.g., Rx waveform 518) that correspond to Tx waveform 516.

In some aspects, RF sensing data (e.g., CSI data) can include information that can be used to determine the manner in which an RF signal (e.g., Tx waveform 516) propagates from RF transmitter 506 to RF receiver 510. RF sensing data can include data that corresponds to the effects on the transmitted RF signal due to scattering, fading, and/or power decay with distance, or any combination thereof. In some examples, RF sensing data can include imaginary data and real data (e.g., I/Q components) corresponding to each tone in the frequency domain over a particular bandwidth.

In some examples, RF sensing data can be used by the processor(s) 522 to calculate distances and angles of arrival that correspond to reflected waveforms, such as Rx waveform 518. In further examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 502) in the surrounding environment in order to detect target presence/proximity.

The processor(s) 522 of the wireless device 500 can calculate distances and angles of arrival corresponding to reflected waveforms (e.g., the distance and angle of arrival corresponding to Rx waveform 518) by utilizing signal processing, machine learning algorithms, any other suitable technique, or any combination thereof. In other examples, wireless device 500 can transmit or send the RF sensing data to at least one processor of another computing device, such as a server or base station, that can perform the calculations to obtain the distance and angle of arrival corresponding to Rx waveform 518 or other reflected waveforms.

In one example, the distance of Rx waveform 518 can be calculated by measuring the difference in time from reception of the leakage signal to the reception of the reflected signals. For example, wireless device 500 can determine a baseline distance of zero that is based on the difference from the time the wireless device 500 transmits Tx waveform 516 to the time it receives leakage signal 520 (e.g., propagation delay). The processor(s) 522 of the wireless device 500 can then determine a distance associated with Rx waveform 518 based on the difference from the time the wireless device 500 transmits Tx waveform 516 to the time it receives Rx waveform 518 (e.g., time of flight, which is also referred to as round trip time (RTT)), which can then be adjusted according to the propagation delay associated with leakage signal 520. In doing so, the processor(s) 522 of the wireless device 500 can determine the distance traveled by Rx waveform 518 which can be used to determine the presence and movement of a target (e.g., target 502) that caused the reflection.

In further examples, the angle of arrival of Rx waveform 518 can be calculated by the processor(s) 522 by measuring the time difference of arrival of Rx waveform 518 between individual elements of a receive antenna array, such as antenna 514. In some examples, the time difference of arrival can be calculated by measuring the difference in received phase at each element in the receive antenna array.

In some cases, the distance and the angle of arrival of Rx waveform 518 can be used by processor(s) 522 to determine the distance between wireless device 500 and target 502 as well as the position of the target 502 relative to the wireless device 500. The distance and the angle of arrival of Rx waveform 518 can also be used to determine presence, movement, proximity, identity, or any combination thereof, of target 502. For example, the processor(s) 522 of the wireless device 500 can utilize the calculated distance and angle of arrival corresponding to Rx waveform 518 to determine that the target 502 is moving towards wireless device 500.

As noted above, wireless device 500 can include mobile devices (e.g., IoT devices, smartphones, laptops, tablets, etc.) or other types of devices. In some examples, wireless device 500 can be configured to obtain device location data and device orientation data together with the RF sensing data. In some instances, device location data and device orientation data can be used to determine or adjust the distance and angle of arrival of a reflected signal such as Rx waveform 518. For example, wireless device 500 may be set on the ground facing the sky as a target 502 (e.g., a vehicle) moves towards it during the RF sensing process. In this instance, wireless device 500 can use its location data and orientation data together with the RF sensing data to determine the direction that the target 502 is moving.

In some examples, device position data can be gathered by wireless device 500 using techniques that include RTT measurements, time of arrival (TOA) measurements, time difference of arrival (TDOA) measurements, passive positioning measurements, angle of arrival (AOA) measurements, angle of departure (AoD) measurements, received signal strength indicator (RSSI) measurements, CSI data, using any other suitable technique, or any combination thereof. In further examples, device orientation data can be obtained from electronic sensors on the wireless device 500, such as a gyroscope, an accelerometer, a compass, a magnetometer, a barometer, any other suitable sensor, or any combination thereof.

FIG. 6 is a diagram illustrating an example of a receiver 604 utilizing RF bistatic sensing techniques with one transmitter 600 for determining one or more characteristics (e.g., location, speed or velocity, heading, etc.) of a target 602 object. For example, the receiver 604 can use the RF bistatic sensing to detect a presence and location of a target 602 (e.g., an object, user, or vehicle), which is illustrated in the form of a vehicle in FIG. 6. In one example, the receiver 604 may be in the form of a base station, such as a gNB.

The bistatic radar system of FIG. 6 includes a transmitter 600 (e.g., a transmit sensing node), which in this figure is depicted to be in the form of a base station (e.g., gNB), and a receiver 604 (e.g., a receive sensing node) that are separated by a distance comparable to the expected target distance. As compared to the monostatic system of FIG. 5, the transmitter 600 and the receiver 604 of the bistatic radar system of FIG. 6 are located remote from one another. Conversely, monostatic radar is a radar system (e.g., the system of FIG. 5) comprising a transmitter (e.g., the RF transmitter 506 of wireless device 500 of FIG. 5) and a receiver (e.g., the RF receiver 510 of wireless device 500 of FIG. 5) that are co-located with one another.

An advantage of bistatic radar (or more generally, multistatic radar, which has more than one receiver) over monostatic radar is the ability to collect radar returns reflected from a scene at angles different than that of a transmitted pulse. This can be of interest to some applications (e.g., vehicle applications, scenes with multiple objects, military applications, etc.) where targets may reflect the transmitted energy in many directions (e.g., where targets are specifically designed to reflect in many directions), which can minimize the energy that is reflected back to the transmitter. It should be noted that, in one or more examples, a monostatic system can coexist with a multistatic radar system, such as when the transmitter also has a co-located receiver.

In some examples, the transmitter 600 and/or the receiver 604 of FIG. 6 can be a mobile phone, a tablet computer, a wearable device, a vehicle, or other device (e.g., device 407 of FIG. 4) that includes at least one RF interface. In some examples, the transmitter 600 and/or the receiver 604 can be a device that provides connectivity for a user device (e.g., for IoT device 407 of FIG. 4), such as a base station (e.g., a gNB, eNB, etc.), a wireless access point (AP), or other device that includes at least one RF interface.

In some aspects, transmitter 600 can include one or more components for transmitting an RF signal. The transmitter 600 can include at least one processor (e.g., the at least one processor 522 of FIG. 5) that is capable of determining signals (e.g., determining the waveforms for the signals) to be transmitted. The transmitter 600 can also include an RF transmitter (e.g., the RF transmitter 506 of FIG. 5) for transmission of a Tx signal comprising Tx waveform 616. The RF transmitter can be a transmitter configured to transmit cellular or telecommunication signals (e.g., a transmitter configured to transmit 5G/NR signals, 4G/LTE signals, or other cellular/telecommunication signals, etc.), a Wi-Fi transmitter, a Bluetooth™ transmitter, any combination thereof, or any other transmitter capable of transmitting an RF signal.

The RF transmitter can be coupled to one or more transmitting antennas, such as a Tx antenna (e.g., the TX antenna 512 of FIG. 5). In some examples, a Tx antenna can be an omnidirectional antenna that is capable of transmitting an RF signal in all directions, or a directional antenna that transmits an RF signal in a particular direction. In some examples, the Tx antenna may include multiple antennas (e.g., elements) configured as an antenna array, which may be used for MIMO techniques.

The receiver 604 can include one or more components for receiving an RF signal. For example, the receiver 604 may include one or more receiving antennas, such as an Rx antenna (e.g., the Rx antenna 514 of FIG. 5). In some examples, an Rx antenna can be an omnidirectional antenna capable of receiving RF signals from multiple directions, or a directional antenna that is configured to receive signals from a particular direction. In further examples, the Rx antenna can include multiple antennas (e.g., elements) configured as an antenna array, which may be used for MIMO techniques.

The receiver 604 may also include an RF receiver (e.g., RF receiver 510 of FIG. 5) coupled to the Rx antenna. The RF receiver may include one or more hardware components for receiving an RF waveform such as a Wi-Fi signal, a Bluetooth™ signal, a 5G/NR signal, or any other RF signal. The output of the RF receiver can be coupled to at least one processor (e.g., the at least one processor 522 of FIG. 5). The processor(s) may be configured to process a received waveform (e.g., Rx waveform 618).

In one or more examples, transmitter 600 can implement RF sensing techniques, for example bistatic sensing techniques, by causing a Tx waveform 616 to be transmitted from a Tx antenna. It should be noted that although the Tx waveform 616 is illustrated as a single line, in some cases, the Tx waveform 616 can be transmitted in all directions by an omnidirectional Tx antenna.

In one or more aspects, one or more parameters associated with the Tx waveform 616 may be used to increase or decrease RF sensing resolution. The parameters may include frequency, bandwidth, number of spatial streams, the number of antennas configured to transmit Tx waveform 616, the number of antennas configured to receive a reflected RF signal (e.g., Rx waveform 618) corresponding to the Tx waveform 616, the number of spatial links (e.g., number of spatial streams multiplied by number of antennas configured to receive an RF signal), the sampling rate, or any combination thereof. The transmitted waveform (e.g., Tx waveform 616) and the received waveform (e.g., the Rx waveform 618) can include one or more radar RF sensing signals (also referred to as RF sensing RSs).

During operation, the receiver 604 (e.g., which operates as a receive sensing node) can receive signals that correspond to Tx waveform 616, which is transmitted by the transmitter 600 (e.g., which operates as a transmit sensing node). For example, the receiver 604 can receive signals that are reflected from objects or people that are within range of the Tx waveform 616, such as Rx waveform 618 reflected from target 602. In some cases, the Rx waveform 618 can include multiple sequences that correspond to multiple copies of a sequence that are included in the Tx waveform 616. In some examples, the receiver 604 may combine the multiple sequences that are received to improve the SNR.

In some examples, RF sensing data can be used by at least one processor within the receiver 604 to calculate distances, angles of arrival, or other characteristics that correspond to reflected waveforms, such as the Rx waveform 618. In other examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 602) in the surrounding environment in order to detect target presence/proximity.

The processor(s) of the receiver 604 can calculate distances and angles of arrival corresponding to reflected waveforms (e.g., the distance and angle of arrival corresponding to the Rx waveform 618) by using signal processing, machine learning algorithms, any other suitable technique, or any combination thereof. In other examples, the receiver 604 can transmit or send the RF sensing data to at least one processor of another computing device, such as a server, that can perform the calculations to obtain the distance and angle of arrival corresponding to the Rx waveform 618 or other reflected waveforms.

In one or more examples, the angle of arrival of the Rx waveform 618 can be calculated by a processor(s) of the receiver 604 by measuring the time difference of arrival of the Rx waveform 618 between individual elements of a receive antenna array of the receiver 604. In some examples, the time difference of arrival can be calculated by measuring the difference in received phase at each element in the receive antenna array.

In some cases, the distance and the angle of arrival of the Rx waveform 618 can be used by the processor(s) of the receiver 604 to determine the distance between the receiver 604 and the target 602 as well as the position of target 602 relative to the receiver 604. The distance and the angle of arrival of the Rx waveform 618 can also be used to determine presence, movement, proximity, identity, or any combination thereof, of the target 602. For example, the processor(s) of the receiver 604 may use the calculated distance and angle of arrival corresponding to the Rx waveform 618 to determine that the target 602 is moving towards the receiver 604.

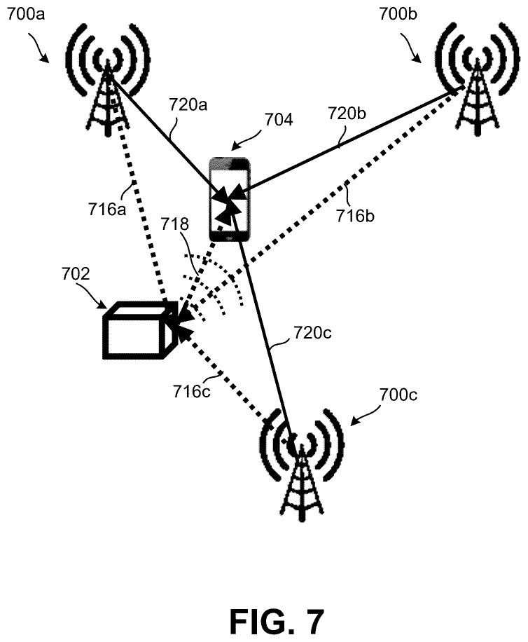

FIG. 7 is a diagram illustrating an example of a receiver 704, in the form of a smart phone, utilizing RF bistatic sensing techniques with multiple transmitters (including a transmitter 700a, a transmitter 700b, and a transmitter 700c), which may be employed to determine one or more characteristics (e.g., location, velocity or speed, heading, etc.) of a target 702 object. For example, the receiver 704 may use RF bistatic sensing to detect a presence and location of a target 702 (e.g., an object, user, or vehicle). The target 702 is depicted in FIG. 7 in the form of an object that does not have communications capabilities (which can be referred to as a device-free object), such as a person, a vehicle (e.g., a vehicle without the ability to transmit and receive messages, such as using C-V2X or DSRC protocols), or other device-free object. The bistatic radar system of FIG. 7 is similar to the bistatic radar system of FIG. 6, except that the bistatic radar system of FIG. 7 has multiple transmitters 700a, 700b, 700c, while the bistatic radar system of FIG. 6 has only one transmitter 600.

The bistatic radar system of FIG. 7 includes multiple transmitters 700a, 700b, 700c (e.g., transmit sensing nodes), which are illustrated to be in the form of base stations. The bistatic radar system of FIG. 7 also includes a receiver 704 (e.g., a receive sensing node), which is depicted in the form of a smart phone. The each of the transmitters 700a, 700b, 700c is separated from the receiver 704 by a distance comparable to the expected distance from the target 702. Similar to the bistatic system of FIG. 6, the transmitters 700a, 700b, 700c and the receiver 704 of the bistatic radar system of FIG. 7 are located remote from one another.

In one or more examples, the transmitters 700a, 700b, 700c and/or the receiver 704 may each be a mobile phone, a tablet computer, a wearable device, a vehicle (e.g., a vehicle configured to transmit and receive communications according to C-V2X, DSRC, or other communication protocol), or other device (e.g., device 407 of FIG. 4) that includes at least one RF interface. In some examples, the transmitters 700a, 700b, 700c and/or the receiver 704 may each be a device that provides connectivity for a user device (e.g., for IoT device 407 of FIG. 4), such as a base station (e.g., a gNB, eNB, etc.), a wireless access point (AP), or other device that includes at least one RF interface.

The transmitters 700a, 700b, 700c may include one or more components for transmitting an RF signal. Each of the transmitters 700a, 700b, 700c may include at least one processor (e.g., the processor(s) 522 of FIG. 5) that is capable of determining signals (e.g., determining the waveforms for the signals) to be transmitted. Each of the transmitters 700a, 700b, 700c can also include an RF transmitter (e.g., the RF transmitter 506 of FIG. 5) for transmission of Tx signals comprising Tx waveforms 716a, 716b, 716c, 720a, 720b, 720c. In one or more examples, Tx waveforms 716a, 716b, 716c are RF sensing signals, and Tx waveforms 720a, 720b, 720c are communications signals. In one or more examples, the Tx waveforms 720a, 720b, 720c are communications signals that may be used for scheduling transmitters (e.g., transmitters 700a, 700b, 700c) and receivers (e.g., receiver 704) for performing RF sensing of a target (e.g., target 702) to obtain location information regarding the target. The RF transmitter can be a transmitter configured to transmit cellular or telecommunication signals (e.g., a transmitter configured to transmit 5G/NR signals, 4G/LTE signals, or other cellular/telecommunication signals, etc.), a Wi-Fi transmitter, a Bluetooth™ transmitter, any combination thereof, or any other transmitter capable of transmitting an RF signal.

The RF transmitter may be coupled to one or more transmitting antennas, such as a Tx antenna (e.g., the TX antenna 512 of FIG. 5). In one or more examples, a Tx antenna can be an omnidirectional antenna that is capable of transmitting an RF signal in all directions, or a directional antenna that transmits an RF signal in a particular direction. The Tx antenna may include multiple antennas (e.g., elements) configured as an antenna array, which may be used for MIMO techniques.

The receiver 704 of FIG. 7 may include one or more components for receiving an RF signal. For example, the receiver 704 can include one or more receiving antennas, such as an Rx antenna (e.g., the Rx antenna 514 of FIG. 5). In one or more examples, an Rx antenna can be an omnidirectional antenna capable of receiving RF signals from multiple directions, or a directional antenna that is configured to receive signals from a particular direction. In some examples, the Rx antenna may include multiple antennas (e.g., elements) configured as an antenna array (e.g., a phase antenna array), which may be used for MIMO techniques.

The receiver 704 can also include an RF receiver (e.g., RF receiver 510 of FIG. 5) coupled to the Rx antenna. The RF receiver may include one or more hardware components for receiving an RF waveform such as a Wi-Fi signal, a Bluetooth™ signal, a 5G/NR signal, or any other RF signal. The output of the RF receiver can be coupled to at least one processor (e.g., the processor(s) 522 of FIG. 5). The processor(s) may be configured to process a received waveform (e.g., Rx waveform 718, which is a reflection (echo) RF sensing signal).

In some examples, the transmitters 700a, 700b, 700c can implement RF sensing techniques, for example bistatic sensing techniques, by causing Tx waveforms 716a, 716b, 716c (e.g., radar sensing signals) to be transmitted from a Tx antenna associated with each of the transmitters 700a, 700b, 700c. Although the Tx waveforms 716a, 716b, 716c are illustrated as single lines, in some cases, the Tx waveforms 716a, 716b, 716c may be transmitted in all directions (e.g., by an omnidirectional Tx antenna associated with each of the transmitters 700a, 700b, 700c).

In one or more aspects, one or more parameters associated with the Tx waveforms 716a, 716b, 716c may be used to increase or decrease RF sensing resolution. The parameters can include, but are not limited to, frequency, bandwidth, number of spatial streams, the number of antennas configured to transmit Tx waveforms 716a, 716b, 716c, the number of antennas configured to receive a reflected (echo) RF signal (e.g., Rx waveform 718) corresponding to each of the Tx waveforms 716a, 716b, 716c, the number of spatial links (e.g., number of spatial streams multiplied by number of antennas configured to receive an RF signal), the sampling rate, or any combination thereof. The transmitted waveforms (e.g., Tx waveforms 716a, 716b, 716c) and the received waveforms (e.g., the Rx waveform 718) may include one or more radar RF sensing signals (also referred to as RF sensing RSs). It should be noted that although only one reflected sensing signal (e.g., Rx waveform 718) is shown in FIG. 7, it is understood that a separate reflection (echo) sensing signal will be generated by each sensing signal (e.g., Tx waveforms 716a, 716b, 716c) reflecting off of the target 702.

During operation of the system of FIG. 7, the receiver 704 (e.g., which operates as a receive sensing node) can receive signals that correspond to Tx waveforms 716a, 716b, 716c, which are transmitted by the transmitters 700a, 700b, 700c (e.g., which each operate as a transmit sensing node). The receiver 704 can receive signals that are reflected from objects or people that are within range of the Tx waveforms 716a, 716b, 716c, such as Rx waveform 718 reflected from the target 702. In one or more examples, the Rx waveform 718 may include multiple sequences that correspond to multiple copies of a sequence that are included in its corresponding Tx waveform 716a, 716b, 716c. In some examples, the receiver 704 may combine the multiple sequences that are received to improve the SNR.

In some examples, RF sensing data can be used by at least one processor within the receiver 704 to calculate distances, angles of arrival (AOA), TDOA, angle of departure (AoD), or other characteristics that correspond to reflected waveforms (e.g., Rx waveform 718). In further examples, RF sensing data can also be used to detect motion, determine location, detect changes in location or motion patterns, or any combination thereof. In one or more examples, the distance and angle of arrival of the reflected signals can be used to identify the size, position, movement, and/or orientation of targets (e.g., target 702) in order to detect target presence/proximity.

The processor(s) of the receiver 704 can calculate distances and angles of arrival corresponding to reflected waveforms (e.g., the distance and angle of arrival corresponding to the Rx waveform 718) by using signal processing, machine learning algorithms, any other suitable technique, or any combination thereof. In one or more examples, the receiver 704 can transmit or send the RF sensing data to at least one processor of another computing device, such as a server, that can perform the calculations to obtain the distance and angle of arrival corresponding to the Rx waveform 718 or other reflected waveforms (not shown).

In one or more examples, a processor(s) of the receiver 704 can calculate the angle of arrival (AOA) of the Rx waveform 718 by measuring the TDOA of the Rx waveform 718 between individual elements of a receive antenna array of the receiver 704. In some examples, the TDOA can be calculated by measuring the difference in received phase at each element in the receive antenna array. In one illustrative example, to determine TDOA, the processor(s) can determine the difference time of arrival of the Rx waveform 718 to the receive antenna array elements, using one of them as a reference. The time difference is proportional to distance differences.

In some cases, the processor(s) of the receiver 704 can use the distance, the AOA, the TDOA, other measured information (e.g., AoD, etc.), any combination thereof, of the Rx waveform 718 to determine the distance between the receiver 704 and the target 702, and determine the position of target 702 relative to the receiver 704. In one example, the processor(s) can apply a multilateration or other location-based algorithm using the distance, AOA, and/or TDOA information as input to determine a position (e.g., 3D position) of the target 702. In other examples, the processor(s) can use the distance, the AOA, and/or the TDOA of the Rx waveform 718 to determine a presence, movement (e.g., velocity or speed, heading or direction or movement, etc.), proximity, identity, any combination thereof, or other characteristic of the target 702. For instance, the processor(s) of the receiver 704 may use the distance, the AOA, and/or the TDOA corresponding to the Rx waveform 718 to determine that the target is moving towards the receiver 704.

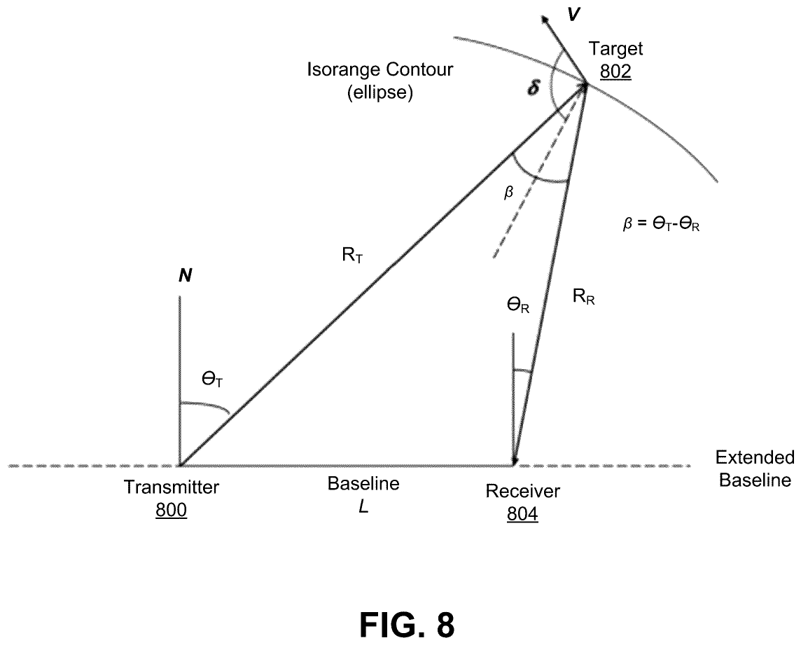

FIG. 8 is a diagram illustrating geometry for bistatic (or monostatic) sensing. FIG. 8 shows a bistatic radar North-reference coordinate system in two-dimensions. In particular, FIG. 8 shows a coordinate system and parameters defining bistatic radar operation in a plane (referred to as a bistatic plane) containing a transmitter 800, a receiver 804, and a target 802. A bistatic triangle lies in the bistatic plane. The transmitter 800, the target 802, and the receiver 804 are shown in relation to one another. The transmitter 800 and the receiver 804 are separated by a baseline distance L. The extended baseline is defined as continuing the baseline distance L beyond either the transmitter 800 or the receiver 804. The target 802 and the transmitter 800 are separated by a distance RT, and the target 802 and the receiver 804 are separated by a distance R_{R}.

Angles θ_{T} and θ_{R} are, respectively, the transmitter 800 and receiver 804 look angles, which are taken as positive when measured clockwise from North (N). The angles θ_{T} and θ_{R} are also referred to as angles of arrival (AOA) or lines of sight (LOS). A bistatic angle (β) is the angle subtended between the transmitter 800, the target 802, and the receiver 804 in the radar. In particular, the bistatic angle is the angle between the transmitter 800 and the receiver 804 with the vertex located at the target 802. The bistatic angle is equal to the transmitter 800 look angle minus the receiver 804 look angle θ_{R} (e.g., β=θ_{T}−θ_{R}).

When the bistatic angle is exactly zero (0), the radar is considered to be a monostatic radar; when the bistatic angle is close to zero, the radar is considered to be pseudo-monostatic; and when the bistatic angle is close to 180 degrees, the radar is considered to be a forward scatter radar. Otherwise, the radar is simply considered to be, and referred to as, a bistatic radar. The bistatic angle (β) can be used in determining the radar cross section of the target.

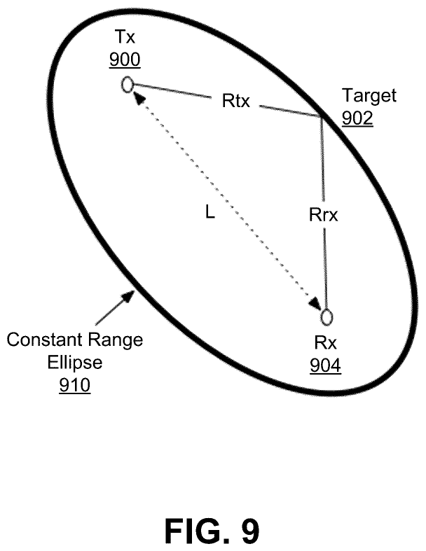

FIG. 9 is a diagram illustrating an example of a bistatic range 910 of bistatic sensing. In this figure, a transmitter (Tx) 900, a target 902, and a receiver (Rx) 904 of a radar are shown in relation to one another. The transmitter 900 and the receiver 904 are separated by a baseline distance L, the target 902 and the transmitter 900 are separated by a distance Rtx, and the target 902 and the receiver 904 are separated by a distance Rrx.

Bistatic range 910 (shown as an ellipse) refers to the measurement range made by radar with a separate transmitter 900 and receiver 904 (e.g., the transmitter 900 and the receiver 904 are located remote from one another). The receiver 904 measures the time of arrival from when the signal is transmitted by the transmitter 900 to when the signal is received by the receiver 904 from the transmitter 900 via the target 902. The bistatic range 910 defines an ellipse of constant bistatic range, referred to an iso-range contour, on which the target 902 lies, with foci centered on the transmitter 900 and the receiver 904. If the target 902 is at range Rrx from the receiver 904 and range Rtx from the transmitter 900, and the receiver 904 and the transmitter 900 are located a distance L apart from one another, then the bistatic range is equal to Rrx+Rtx−L. It should be noted that motion of the target 902 causes a rate of change of bistatic range, which results in bistatic Doppler shift.

Generally, constant bistatic range points draw an ellipsoid, with the transmitter 900 and the receiver 904 positions as the focal points. The bistatic iso-range contours are where the ground slices the ellipsoid. When the ground is flat, this intercept forms an ellipse (e.g., bistatic range 910). Note that except when the two platforms have equal altitude, these ellipses are not centered on a specular point.

FIG. 10 is a diagram illustrating an example of a system utilizing RF multi-static sensing techniques with one transmitter and multiple receivers, which may be employed by the disclosed systems and techniques described herein to determine one or more characteristics of a target object. In FIG. 10, a system 1000 is shown to include a network device 1010 in the form of a base station (e.g., gNB or a portion of a gNB, such as a CU, DU, RU, Near-RT RIC, Non-RT RIC, etc.). The network device 1010 can operate as a radar Tx for sensing purposes. Also shown are network devices 1020a, 1020b, each in the form of a base station (e.g., gNB or a portion of a gNB, such as a CU, DU, RU, Near-RT RIC, Non-RT RIC, etc.). The network devices 1020a, 1020b can each operate as a radar Rx for sensing purposes. The system 1000 also includes a network entities 1040, which is in the form of a sensing server.

The system 1000 may include more or less network devices and/or more or less network entities, than as shown in FIG. 10. In addition, the system 1000 may include different types of network devices (e.g., vehicles, UEs, repeaters, and/or reconfigurable intelligent surfaces (RISs)) and/or different types of network entities (e.g., network servers and/or location servers) than as shown in FIG. 10. Also, a UE may be employed as a radar Tx (e.g., network device 1010) instead of a base station (e.g., gNB) as is shown in FIG. 10. A UE may be employed as a radar Rx (e.g., network device 1020a, 1020b) instead of a base station (e.g., gNB) as is shown in FIG. 10. In one or more examples, the network devices 1010, 1020a, 1020b may be equipped with heterogeneous capability, which may include, but is not limited to, 4G/5G cellular connectivity, GPS capability, camera capability, radar capability, and/or LIDAR capability. The network devices 1010, 1020a, 1020b and the network entity 1040 may be capable of performing wireless communications with each other via communications signals (e.g., signals 1050a, 1050b, 1050c, 1050d, 1050e).

In one or more examples, the network devices 1010, 1020a, 1020b may be capable of transmitting and receiving sensing signals of some kind (e.g., camera, RF sensing signals, optical sensing signals, etc.). In some cases, the network devices 1010, 1020a, 1020b may transmit and receive sensing signals (e.g., RF sensing signals 1060a, 1060b, 1060c) for using one or more sensors to detect nearby targets (e.g., target 1030, which is in the form of a vehicle). In some cases, the network devices 1010, 1020a, 1020b can detect nearby targets based on one or more images or frames captured using one or more cameras.

The network device 1010, which may operate as a radar Tx, may perform RF sensing (e.g., multi-static sensing) of at least one target (e.g., target 1030) to obtain RF sensing measurements (e.g., Doppler, RTT, TOA, and/or TDOA measurements) of the target(s) (e.g., target 1030). The RF sensing measurements of the target(s) (e.g., target 1030) can be used (e.g., by at least one processor(s) of at least one of the network devices 1010, 1020a, 1020b and/or the network entity 1040) to determine one or more characteristics (e.g., speed, location, distance, movement, heading, size, and/or other characteristics) of the target(s) (e.g., target 1030).

As previously mentioned, generally, sensing involves monitoring moving targets (e.g., target 1030) with different motions (e.g., a moving car or pedestrian, a body motion of a person, such as breathing, and/or other micro-motions related to a target). Doppler, which measures the phase variation in a signal and is indicative of motion, is an important characteristic for sensing of a target (e.g., target 1030). As such, in order to obtain an accurate estimation of the motion of the target, the phase of the signal should be continuous (e.g., the signal should maintain phase continuity).

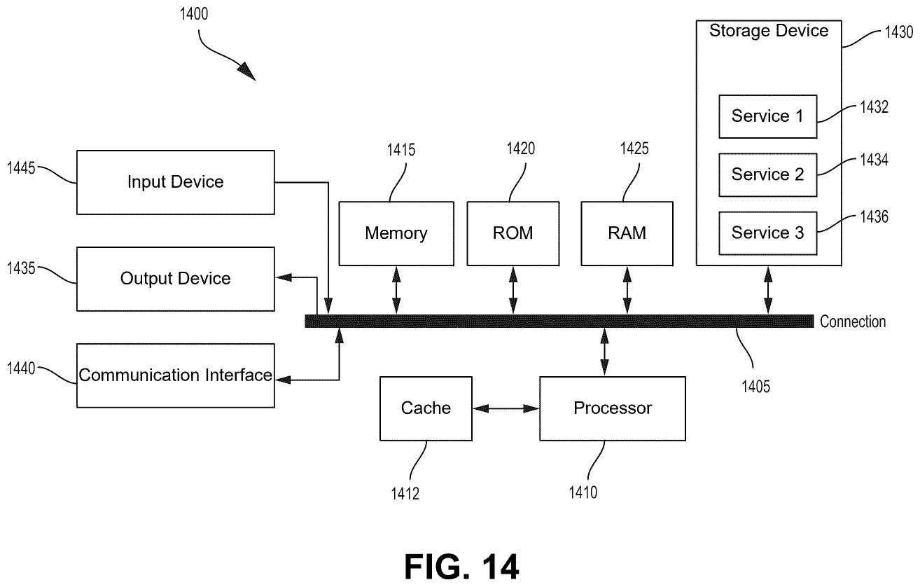

During operation of the system 1000, for example when performing multi-static sensing of a target (e.g., target 1030), the network device 1010 (e.g., base station), operating as a radar Tx, may transmit an RF sensing signal 1060a towards the target (e.g., target 1030). The sensing signal 1060a can reflect off of the target (e.g., target 1030) to produce RF reflection sensing signals 1060b, 1060c, which may be reflected towards the network device 1020a, 1020b, respectively. The network devices 1020a, 1020b, each operating as a radar Rx, can receive the reflection sensing signals 1060a, 1060b. After the network devices 1020a, 1020b receive the reflection sensing signals 1060a, 1060b, the network devices 1020a, 1020b can obtain measurements (e.g., Doppler, RTT, TOA, and/or TDOA measurements) of the reflection sensing signal 1060a, 1060b. At least one processor (e.g., processor 1410 of FIG. 14) of at least one of the network devices 1010, 1020a, 1020b and/or the network entity 1040 may then determine or compute the characteristics (e.g., speed, location, distance, movement, heading, size, etc.) of the target (e.g., target 1030) by using sensing measurements (e.g., Doppler, RTT, TOA, and/or TDOA measurements) from the received reflection sensing signals 1060a, 1060b.

In some examples, the network devices 1020a, 1020b may transmit the measurements (e.g., Doppler, RTT, TOA, and/or TDOA measurements) and/or determined characteristics (e.g., speed, location, distance, movement, heading, size, etc.) of the target (e.g., target 1030) to the network device 1010 and/or the network entity 1040 via communication signals 1050a, 1050b, 1050d, 1050e.

As previously mentioned, increasingly, systems and devices (e.g., autonomous vehicles, such as autonomous and semi-autonomous cars, drones, mobile robots, mobile devices, cellular base stations, XR devices, and other suitable systems or devices) include multiple sensors (e.g., camera sensors, radar sensors, and/or LIDAR sensors) to gather information about the environment, as well as processing systems to process the information gathered, such as for route planning, navigation, collision avoidance, etc. Sensor data (e.g., RF sensor data captured from one or more radar sensors) may be gathered, transformed, and analyzed to detect objects. Securing sensor data (e.g., securing RF sensor data against jamming) for devices is important to ensure data integrity and prevent spoofer attacks.

Currently, RF sensing is one potentially important area for 6G technology. RF sensing may be employed for object detection for various different use cases including, but not limited to, vehicle (e.g., terrestrial vehicle) detection and unmanned aerial vehicle (UAV) detection. Security is vital for 6G and, as such, security in RF sensing should be carefully considered. RF sensing is vulnerable to spoofer attacks, such as susceptible to jamming attacks, because the reflected signals received in RF sensing are weak (e.g., having a low signal strength), due to the reflected signals being reflected NLOS signals. As such, the SNR of the received reflected signals is typically lower than the SNR for communications signals, which are typically non-reflected LOS signals. One type of jamming attack is a repeater attack, where a jammer (e.g., a spoofer) intercepts a transmitted sensing signal, and replays the sensing signal with a certain delay and propagates the sensing signal at a certain direction. Repeater attacks can be problematic for traditional radar systems (e.g., having only a single transmitter and a single receiver), and can be difficult to defend against. Therefore, improved systems and techniques for combatting repeater attacks in RF sensing can be useful.

As noted previously, systems and techniques are described herein that can combat repeater attacks in RF sensing using a network of sensing entities. For instance, according to some aspects, the systems and techniques may combat repeater attacks by providing jamming detection and anti-jamming measures. In some examples, the range of measures can depend upon the jammer capability.

In general, jammers may be sorted into different categories having different signal processing capabilities, which can impact the difficulty and complexity of the counter measures chosen to combat the repeater attacks performed by the jammers. In one or more examples, a first category of jammers includes jammers with no digital signal processing capability. The replayed signal by these jammers has an analog delay, which can either be fixed or variable. The replayed signal's beam can be either fixed or randomly selected. These jammers have no control of the Doppler shift in the signal.

A second category of jammers includes jammers with a digital signal processor capability, which includes digital beamforming (e.g., to propagate the replayed signal in a specific direction) and producing a Doppler shift in the signal (e.g., manipulate the Doppler in the signal). However, these jammers have no knowledge of the digital characteristics of the RF sensing reference signal or of the locations of the RF sensing receivers.

A third category of jammers includes jammers with a digital signal processing capability, which includes digital beamforming and producing a Doppler shift in the signal. These jammers have knowledge of the digital characteristics of RF sensing reference signal, but do not have knowledge of the locations of the RF sensing receivers. In one or more examples, knowledge of the digital characteristics of RF sensing reference signal can be gained by the jammers monitoring the RF sensing signal over-the-air (OTA) or by intercepting upper layer configuration messages.

A fourth category of jammers includes jammers with a digital signal processing capability, which includes digital beamforming (e.g., to propagate the replayed signal in a direction towards a receiver in a known location) and producing a Doppler shift in the signal. These jammers have knowledge of both the digital characteristics of RF sensing reference signal and the locations of the RF sensing receivers. In some examples, these jammers can gain knowledge of the digital characteristics of RF sensing reference signal by the jammers monitoring the RF sensing signal OTA or by intercepting upper layer configuration messages.

In some examples, the system and techniques employ a network of sensing entities (e.g., radar receivers), which may be distinguished from traditional radar systems utilizing only a single transmitter and a single receiver, to combat jamming in the form of repeater attacks. The term “sensing entity” may refer to any type of sensing entity, such as a base station, user equipment (UE), or a controlled repeater. In one or more examples, the systems and techniques provide privacy protection against unwanted sensing, which may allow for legitimate use cases for jamming techniques.

In one or more aspects, there can be difficulties and vulnerabilities with respect to jamming (e.g., repeater attacks) at a given RF sensing receiver. For example, it can be very difficult to distinguish between a real RF sensing signal and a replayed RF sensing signal (e.g., even for jammers of the first category).

In some examples, a network device (e.g., a RF sensing receiver) or a network entity (e.g., a sensing function) may track the target (e.g., vehicle) over a period of time to observe a velocity of the target and a Doppler of the target. In one or more examples, the network device (or network entity) may determine a jamming scenario is present based on determining a discrepancy between the velocity of the target and the Doppler of the target over the period of time. However, jamming scenarios may not always be detected by monitoring for this discrepancy because Doppler shift is only associated with movement along the line between the RF sensing transmitter and the RF sensing receiver. If the movement is perpendicular to this line, there will be no Doppler shift present.

In one or more examples, a transmit sensing signal may include multiple frequencies (e.g., potentially in non-adjacent, or even far apart frequency bands, such as from seven to twenty-two Gigahertz) for combatting jamming. The use of multiple frequencies can allow for a network device (e.g., a RF sensing receiver) or a network entity (e.g., a sensing function) to be able to detect jamming because it can be difficult for a jammer to jam multiple frequencies in a consistent way.

In one or more examples, a network device (e.g., a RF sensing receiver) or a network entity (e.g., a sensing function) may employ detection of and reliance on an earliest path (e.g., an earliest received reflection signal) as a countermeasure for combatting jamming. However, the use of the detection of an earliest path (e.g., earliest received reflection signal) for combatting jamming has some limitations. For an example limitation, a replayed signal, by a jammer, may be strong enough to dwarf (e.g., overpower in signal strength) the reflection signal from the earliest path through inter-path interference.

For another example limitation, third and fourth category jammers may be able to transmit signals that may appear to be received earlier than the real earliest received reflection signal (e.g., which may be referred to as early fake path generation). In one or more examples, the fake path may be generated by the jammers, based on a physical sense if the jammers know the transmission timing of the sensing reference signal. The jammers can then transmit a similar signal that arrives before the earliest actual path (e.g., before the real earliest received reflection signal). In some examples, the fake path may be generated by the jammers, based on a digital sense if the jammers know the codes used in the sensing reference signal. The jammers can then manipulate the codes used in the replayed signal such that a code phase of the replayed signal is ahead of that of the real signal (e.g., the real earliest received reflection signal). In one or more examples, detecting a discrepancy between the velocity and Doppler can be applied to each of the multiple paths (e.g., reflection signals) received at each receiver.

In one or more aspects, certain improvements may be employed for a single RF sensing receiver for combatting jamming (e.g., repeater attacks). In one or more examples, improvements can be made for the earliest path detection by reducing the inter-path interference. In some examples, the transmit sensing signal may include a pulse with low (e.g., suppressed) ripples, which may be achieved by using a larger bandwidth or a larger main lobe (e.g., at the cost of a slightly worse time resolution on the real earliest path). In one or more examples, a Gaussian pulse may be employed for a pulse with low (e.g., suppressed) ripples (e.g., although a Gaussian pulse may require a long digital filter with many taps with good quantization to be generated).

In some examples, the transmit sensing signal may be encoded (e.g., modulated) with a code with an auto-correlation function (e.g., a low autocorrelation function). In one or more examples, a Zadoff-Chu code may be employed for the code with an auto-correlation function (e.g., a low autocorrelation function). In some examples, the autocorrelation (e.g., low autocorrelation) may reduce the randomness in the codes.

In one or more examples, transmission timing, a code, and phase of a code of the transmit sensing signal may randomized to deny an opportunity to a jammer to manipulate the transmit sensing signal. In some examples, this randomization can be simple to implement for a monostatic sensing device (e.g., because the monostatic sensing device is both a sensing receiver and transmitter and, as such, does not need to notify other devices of this randomization). A secure configuration for notifying about this randomization is needed for bistatic sensing devices and multi-static sensing devices (e.g., because bistatic sensing devices and multi-static sensing devices have separate sensing receivers and transmitters).

In one or more aspects, countermeasures to combat jamming (e.g., repeater attacks) may include redundancy and consistency checks. In one or more examples, redundancy can be implemented in the time domain (e.g., by performing object tracking), the frequency domain (e.g., by utilizing transmit signals with multiple frequency bands), and/or the spatial domain (e.g., by employing multiple RF sensing receivers). It can be difficult for a jammer to provide (e.g., simulate) a false (e.g., fake) location that is consistent with all of these different redundant dimensions (e.g., time domain, frequency domain, and spatial domain). Redundancy provided by the spatial domain can provide the most powerful countermeasures to jamming. Multiple entity solutions (e.g., employing multiple RF sensing receivers) can have an advantage of utilizing communication networks with many transceivers over traditional radar systems, which only have a small number of powerful radar sensors.

In one or more examples, strict synchronization among the sensing entities (e.g., RF sensing entities (such as RF sensing servers), RF sensing transmitters, and RF sensing receivers) is not required. However, synchronization between an RF sensing receiver and an RF sensing transmitter is assumed. In some examples, a lack of synchronization can be overcome by adding extra sensing entities, such as in Global Navigation Satellite System (GNSS) satellites with unknown timing offsets.

In one or more aspects, countermeasures to combat jamming (e.g., repeater attacks) may utilize angular measurements, such as angle of arrival (AOA) measurements, of the received RF reflection sensing signals. In one or more examples, it can be relatively simple for a jammer to jam a monostatic receiver with AOA measurements (e.g., because the jammer can simply send a signal in the exact opposite direction of the incoming RF transmit sensing signal). Conversely, it can be very difficult to falsify (e.g., fake) AOA measurements for multiple receivers (e.g., in a multi-static sensing scenario), even by a category four jammer with knowledge of the RF transmit sensing signal and the location of the RF sensing receivers.

In one or more examples, the jammer may falsify (e.g., fake) the propagation delay of a reflection sensing signal in an arbitrary way. However, the jammer may not be able to falsify (e.g., fake) the propagation direction of a reflection sensing signal in an arbitrary way. The propagation of a signal is determined by physics and by the media between the jammer and RF sensing receiver. If the chosen beamforming, by a jammer, for a falsified (e.g., fake) signal is far from the natural propagation direction, the falsified (e.g., fake) signal may not reach the RF sensing receiver. However, even if the falsified signal reaches the RF sensing receiver, the location origin of the falsified signal may not be consistent with the location calculated based on a timing measurement (e.g., a time of arrival (TOA) measurement).

In some examples, a cross-check performed on AoA measurements across multiple RF sensing receivers can be an important countermeasure for jamming (e.g., repeater attacks). A cross-check can be effective without the use of timing measurements and can require less processing without the use of timing measurements. Bistatic sensing and multi-static sensing can be more secure because the jammer must know the location of the RF sensing receiver (or the natural propagation direction) to be able to properly beamform the falsified signal such that the falsified signal is directed towards the RF sensing receiver. In one or more examples, a network device (e.g., a RF sensing receiver) or a network entity (e.g., a sensing function) may determine that a jamming scenario is present when there is a discrepancy between AOA measurements and a Doppler shift of a target over a period of time.

In one or more aspects, countermeasures to combat jamming (e.g., repeater attacks) may utilize distance measurements, which may be derived from time of arrival (TOA) measurements of the received RF reflection sensing signals. Distance measurements in RF sensing are typically based on timing measurements (e.g., TOA measurements), which are first converted to a propagation delay and then to a distance. In one or more examples, distance measurements may be based on received power measurements. However, the accuracy of this method may be low due to unknown target's radar cross section (RCS), size, and angle of reflection. A jammer (e.g., of any of the categories) can easily spoof a single RF sensing receiver.

In one or more examples, in a two-dimensional (2D) scenario, assuming the height of a target is known, the distance measurements at three sensing entities (e.g., RF sensing receivers) can be fused together to combat category one and three jammers, because these types of jammers are not able to calculate accurate additional delays for three or more entities because these jammers do not know the locations of the entities. However, these jammers can accurately calculate additional delays for two entities.

In some examples, in a three-dimensional (3D) scenario, the distance measurements at four sensing entities (e.g., RF sensing receivers) can be fused together to combat category one and three jammers, because these types of jammers are not able to calculate accurate additional delays for four or more entities because these jammers do not know the locations of the entities. However, these jammers can accurately calculate additional delays for three entities.

In one or more examples, bistatic and multi-static sensing does not provide for any added resistance for these distance-based countermeasures. In some examples, it can be difficult to combat category four jammers using distance measurements alone, because these types of jammers are able to add a specific delay for each of the RF sensing receivers because these jammers have knowledge of the locations of the receivers (e.g., regardless of how many receivers are being utilized for the sensing).

In one or more aspects, countermeasures to combat jamming (e.g., repeater attacks) may utilize a combination of distance measurements and angular measurements (e.g., AOA measurements). In one or more examples, in a 2D scenario, assuming the height of a target is known, the distance measurements and angular measurements at three sensing entities (e.g., RF sensing receivers) can be fused together to combat category one and three jammers. In some examples, in a 3D scenario, the distance measurements and angular measurements at four sensing entities (e.g., RF sensing receivers) can be fused together to combat category one and three jammers.

In one or more examples, some angular measurements are needed to be able to combat category four jammers. In some examples, bistatic sensing and multi-static sensing can offer an extra defense for angular-based measurements. In one or more examples, the multiple measurements may be taken (e.g., obtained) at multiple (e.g., at least two) RF sensing entities (e.g., RF sensing receivers). In some examples, the selection of these sensing entities (e.g., RF sensing receivers) may consider a minimization of an error in the estimated location of a target, which can be determined based on (e.g., by using) the obtained sensing measurements. The location error may be calculated using a technique similar to Dilution of Precision (DoP) based on (e.g., utilizing) a mixture of timing measurements (e.g., TOA measurements) and angular measurements (AOA measurements).

In one or more aspects, DOP, or geometric dilution of precision (GDOP), is a term used in positioning to specify the error propagation as a mathematical effect of reference point geometry on positional measurement precision. In one or more examples, GDOP is used to state how errors in a measurement(s) will affect the final state estimation (e.g., final estimated location of a target). Commonly, GDOP is expressed as the ratio of the root mean square (rms) position error to the rms measurement (distance measurement or angle measurement) error (e.g., GDOP=σₚ/σ). A smaller DOP is preferred. A small DOP means that small changes in the measurement(s) will not result in large errors in the location output (e.g., estimated location of a target).

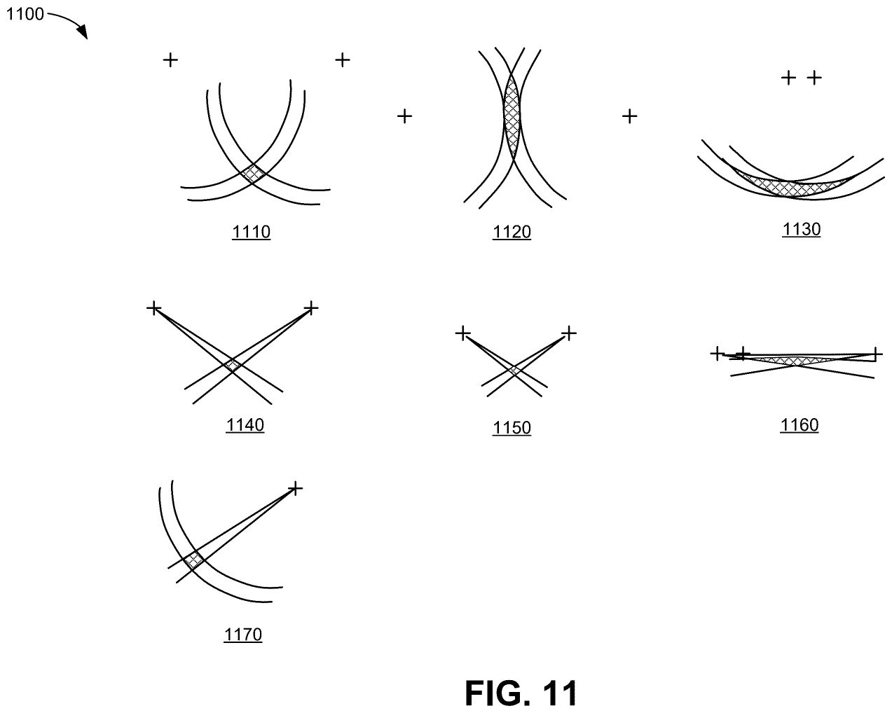

FIG. 11 shows several examples of GDOP when TOA measurements, AOA measurements, and TOA and AOA measurements are used for positioning. In particular, FIG. 11 is a diagram illustrating examples 1100 of GDOP scenarios where TOA measurements are used for positioning, AOA measurements are used for positioning, and a combination of TOA and AOA measurements are used for positioning. In FIG. 11, three typical scenarios 1110, 1120, and 1130 are shown when TOA measurements are used for positioning. The crosses in FIG. 11 represent the sensing entities (e.g., base stations), the two concentric arcs in FIG. 11 shows a range measurement error.

In one or more examples, scenario 1110 shows an example of a good DOP. The angle of intersection of the two lines which connect the area of interest (e.g., which may include a target and is represented in FIG. 11 as a shaded area) and the base stations is about ninety degrees. Scenarios 1120 and 1130 show examples of poor DOP.

In some examples, scenarios 1140, 1150, and 1160 show examples of using AOA measurements for positioning, where scenarios 1150 and 1160 are similar to each other, but on a different scale. The scenarios 1150 and 1160 show that the DOP, when using AOA measurements, is a quantity with a unit. When the distance from a base station to a target increases, the AOA measurement error increases. In the TOA scenarios (e.g., scenarios 1110, 1120, 1130), the range (e.g., distance) measurement error is always the same (e.g., in an ideal situation).

In one or more examples, scenarios 1150 and 1160 also reveal that the DOP is poor, when the positioning area is near the line that connects the two base stations, and the DOP is good when the two lines, which connect the mobile station and the base stations, create a right angle.

In some examples, scenario 1170 shows an example of using combined TOA measurements and AOA measurements for positioning. In scenario 1170, the DOP is shown to increase when the mobile station is located further away from the base station (e.g., assuming that one base station can provide both AOA and TOA measurements).

In one or more aspects, for 3D scenarios, if there are n number of base stations (e.g., sensing entities) for one target (e.g., mobile station), the total number of measurements is 3n, including n number of range (e.g., distance) measurements, n number of azimuth-like angle measurements, and n number of elevation-like angle measurements.

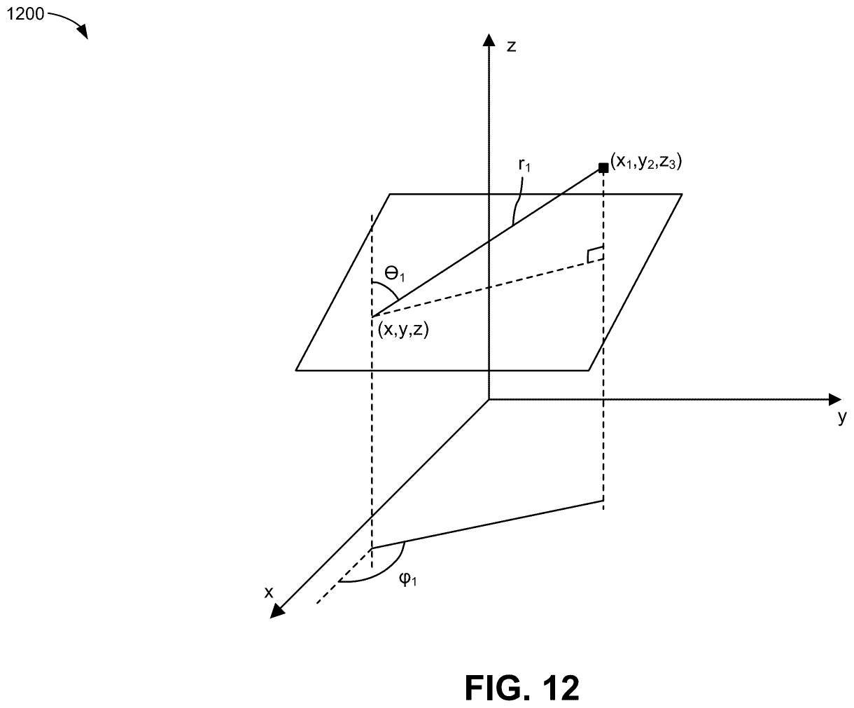

In one or more examples, it can be assumed that an i-th sensing entity (e.g., RF sensing receiver) is located at (xᵢ, yᵢ zᵢ), the estimated target location is at (x, y, z), and the angular measurements are (θᵢ, φᵢ) in spherical coordinates. FIG. 12 is a graph 1200 illustrating an example of 3D geometry showing the angular measurements are (θᵢ, φᵢ) and the range (rᵢ).

The equations for determining the angular measurements (θᵢ, φᵢ) and the range (rᵢ) are as follows:

$$\{ \begin{matrix}{tan}^{- 1} \frac{y - {y}_{i}}{x - {x}_{i}} = {φ}_{i} \\ \begin{matrix}{tan}^{- 1} \frac{{s}_{i}}{z - {z}_{i}} = {θ}_{i} & \end{matrix} \\ \sqrt{{( x - {x}_{i} )}^{2} + {( y - {y}_{i} )}^{2} + {( z - {z}_{i} )}^{2}} = {r}_{i}\end{matrix}$$

$${s}_{i} = \sqrt{{( x - {x}_{i} )}^{2} + {( y - {y}_{i} )}^{2}}$$

In one or more examples, the derivatives are linked as AdX=db, where:

$$A = [ \begin{matrix}- \frac{y - {y}_{1}}{{s}_{1}^{2}} & \frac{x - {x}_{1}}{{s}_{1}^{2}} & 0 \\ - \frac{y - {y}_{n}}{{s}_{n}^{2}} & \frac{x - {x}_{n}}{{s}_{n}^{2}} & 0 \\ \frac{( x - {x}_{1} ) ( z - {z}_{1} )}{{u}_{n}^{2} {s}_{n}} & \frac{( y - {y}_{1} ) ( z - {z}_{1} )}{{u}_{1}^{2} {s}_{n}} & - \frac{{s}_{1}}{{u}_{1}^{2}} \\ \frac{( x - {x}_{n} ) ( z - {z}_{n} )}{{u}_{n}^{2} {s}_{n}} & \frac{( y - {y}_{n} ) ( z - {z}_{n} )}{{u}_{n}^{2} {s}_{n}} & - \frac{{s}_{n}}{{u}_{n}^{2}} \\ \frac{x - {x}_{1}}{{u}_{1}} & \frac{y - {y}_{1}}{{u}_{1}} & \frac{z - {z}_{1}}{{u}_{1}} \\ \frac{x - {x}_{n}}{{u}_{n}} & \frac{y - {y}_{n}}{{u}_{n}} & \frac{z - {z}_{n}}{{u}_{n}}\end{matrix} ]$$

The measured location for the target is:

$$dX = [ \begin{matrix}dx \\ dy \\ dz\end{matrix} ]$$

The measured variables are:

$$db = [ \begin{matrix}d {φ}_{1} \\ ⋯ \\ d {φ}_{n} \\ d {θ}_{1} \\ ⋯ \\ d {θ}_{n} \\ {dr}_{1} \\ ⋮ \\ {dr}_{n}\end{matrix} ]$$

In one or more examples, a least square solution may be applied, where:

$$cov ( dX ) = E ( {dXdX}^{T} ) = {( {A}^{T} WA )}^{- 1} ,$$

with W as the covariance matrix of:

$$db = [ \begin{matrix}d {φ}_{1} \\ ⋯ \\ d {φ}_{n} \\ d {θ}_{1} \\ ⋯ \\ d {θ}_{n} \\ {dr}_{1} \\ ⋮ \\ {dr}_{n}\end{matrix} ]$$

The errors in the measurements of the different parameters (e.g., the distance measurements and the AOA measurements) can be assumed to be independent. As such, w (weights, such as the covariance matrix) can be assumed to be diagonal (e.g., different weights can be applied to the different parameters, such as the distance measurements and the AOA measurements) with elements diagonal designated as along the {w_{φ}_{₁}, w_{φ}_{₂}, . . . , w_{θ}_{₁}, w_{θ}_{₂}, . . . , w_{θ}_{ₙ}, wᵣ, wᵣ_{₂}, . . . , wᵣ_{ₙ}

In one or more examples, for the diagonal elements of W (weights):

$${w}_{{r}_{i}} = \frac{{σ}_{{r}_{i}}^{2}}{S N R}$$

where σᵣ_{ᵢ}², is a normalized variance, which can be the square of the three decibel (3-dB) width of the pulse in the signal for sensing entity i. Note that σᵣ_{ᵢ}² is inversely proportional to the signal bandwidth.

$${w}_{{θ}_{i}} = \frac{{σ}_{{θ}_{i}}^{2}}{S N R}$$

where

$${σ}_{{θ}_{i}}^{2}$$

is a normalized variance, which can be the square of the 3-db width of receive beam along the elevation angle at sensing entity i.

$${w}_{{φ}_{i}} = \frac{{σ}_{{φ}_{i}}^{2}}{S N R}$$

where

$${σ}_{{φ}_{i}}^{2}$$

is a normalized variance, when can be the square of the 3-db width of receive beam along the azimuth angle at sensing entity i.

In one or more examples, the SNR reflects the antenna main lobe coverage as a function of the angles θᵢ and φᵢ. Doppler measurements are not in this formulation explicitly, but spreading the entities angularly can make the Doppler measurements useful because each entity can effectively measure a different projection of speed toward the respective line between the entity and the target.

In some aspects, W can be non-diagonal if there are correlations between the errors of any measurements of rᵢ, θᵢ or φᵢ.

In one or more aspects, during operation of the systems and techniques for wireless communications, a network entity may receive information associated with a sensing signal transmitted by a network device (e.g., an RF sensing transmitter, such as network device 1010 of FIG. 10). The sensing signal interacts with a target object (e.g., a vehicle, such as target 1030 of FIG. 10) and is received by a plurality of network devices (e.g., RF sensing receivers, such as network devices 1020a, 1020b of FIG. 10). In one or more examples, the information may include a plurality of TOA measurements and a plurality of AOA measurements by the plurality of network devices associated with the sensing signal after interaction with the target object.

In some examples, the network entity may be a sensing function. In one or more examples, the sensing function may be implemented in a sensing server (e.g., network entity 1040 of FIG. 10) and/or in a network device (e.g., one of the network devices 1020a, 1020b of FIG. 10) of the plurality of network devices. In some examples, the network device of the plurality of network devices may be a receiver device (e.g., an RF sensing receiver, such as network devices 1020a, 1020b of FIG. 10). In some examples, the network device that transmits the sensing signal may be a transmitter device (e.g., an RF sensing transmitter, such as network device 1010 of FIG. 10). In one or more examples, the network device of the plurality of network devices may be located at a known first position, and the network device that transmits the sensing signal may be located at a known second position. In one or more examples, the first network device (e.g., an RF sensing receiver) of the plurality of network devices and at least one other network device (e.g., another RF sensing receiver, such as in a multi-static sensing scenario) of the plurality of network devices may be separated (or spread) spatially (e.g., in the angular domain) from each other around the target object.

The network entity may determine a plurality of distance measurements associated with the sensing signal after interaction with the target object based on the plurality of TOA measurements. The network entity may apply first weights to the plurality of distance measurements to produce a plurality of weighted distance measurements and can apply second weights to the plurality of AOA measurements to produce a plurality of weighted AOA measurements. The network entity can determine an estimated location of the target object based on at least a subset of the plurality of weighted distance measurements and at least a subset of the plurality of weighted AOA measurements after interaction with the target object.

In one or more examples, the first weightings and the second weightings may be based on a signal to noise ratio (SNR) of the sensing signal after interaction with the target object, an accuracy of the plurality of TOA measurements, and/or an accuracy of the plurality of AOA measurements.

The network entity may determine an error in the estimated location of the target object based on the plurality of weighted distance measurements and the plurality of weighted AOA measurements after interaction with the target object. In one or more examples, the network entity may further determine a jamming scenario is present based on the error in the estimated location of the target object being greater than an error threshold (e.g., a variance of a predetermined multiple of standard deviation).

In some examples, the network entity may further determine a jamming scenario is present based on determining a discrepancy in the plurality of AOA measurements. In one or more examples, the network entity may determine a jamming scenario is present based on a discrepancy in the plurality of distance measurements.

In one or more aspects, the determination of a jamming scenario can trigger the configuration of additional multiple sensing entities (e.g., RF sensing receivers). In some examples, the detection of an anomaly can indicate a jamming scenario. In one or more examples, an anomaly may be in the form of a distance estimate that is out of range or a distance estimate that is inconsistent with the path loss (e.g., with a known RCS of the target object).

In one or more examples, the added sensing entity (e.g., RF sensing receiver) may be in the form of a base station (e.g., gNB), a UE, a RIS, a repeater, etc. In some examples, different added sensing entities (e.g., different RF sensing receivers) may have different capabilities, such as available time, bandwidth, predicted sensing SNR, beamwidth, etc. In one or more examples, the bandwidth, SNR, as well pulse shape can affect the variance in the distance estimate, SNR, and beamwidth, which can affect the variance in the AOA measurements. In some examples, the geometry of the sensing entities (e.g., RF sensing receivers) can also affect the positioning quality.

In some aspects, one way to select the sensing entities (e.g., RF sensing receivers) to add is to minimize (e.g., among the candidate sensing entities to add) the total variance in the position estimate, where: trace[cov(dX)]=trace[E(dXdXT)]=trace[(ATWA)−1]. The position estimate can use the current estimate before adding the new sensing entities.

In one or more examples, the sensing entities (e.g., RF sensing receivers) can be selected such that they are evenly distributed along the azimuth angle. In some examples, the sensing entities can be selected based on a consideration of beamwidth, bandwidth, and SNR of the sensing entities. In some cases, selecting a base station to be employed for an additional sensing entity can be advantageous due it its larger bandwidth, narrow beam, and high SNR (e.g., than of a UE). In some examples, a UE may be selected to serve as an additional sensing entity. Doppler measurements are not in this formulation explicitly. However, spreading out the sensing entities angularly can make the Doppler measurements are useful because each sensing entity can effectively measure a different projection of speed towards the respective line (e.g., LOS) between the sensing entity and the target.

In some aspects, with the use of multiple sensing entities (e.g., RF sensing receivers) and the computed variance and standard deviation, consistency checks can be applied to detect a jamming scenario.

In some cases, a consistency check (e.g., consistency check algorithm) may be performed by finding a subset (e.g., of a full set) of measured parameters or sensing entities. A position estimate (e.g., for a target) can then be determined by using the subset. If the position estimate (e.g., based on the subset) deviates with a position estimate (e.g., made based on the full set) by more than a predetermined multiple of standard deviation, a jammer scenario can be determined. In some examples, the estimated position of a target may be calculated using Kalman filters incorporating distance measurements, angle measurements, and Doppler measurements. In some cases, an additional consistency check may be performed by using a different subset (e.g., of the full set) or using a subset of the initial subset.

In some examples, a consistency check (e.g., consistency check algorithm) should consider multiple paths observed at each sensing entity (e.g., RF sensing receiver). The consistency algorithm can take one path from each sensing entity at a time, and can cycle through the multiple paths. In one or more examples, if multiple frequencies are used in the transmit sensing signal, measurements for each of the frequencies may be used in the overall result set (e.g., the full set) to check consistency with subsets.

In one or more aspects, a central sensing server (e.g., or sensing function) may be employed in the core network. In one or more examples, there should be an overlap between the coverage areas of two sensing servers such that that multi-static sensing (e.g., by multiple RF sensing receivers) can occur within the overlapping area.

In some cases, sensing entities (e.g., RF sensing receivers) may each send (e.g., report) sensing capability report to a sensing server (e.g., or a sensing function). Each sensing capability report may include a capability related to bandwidth, time (e.g., based on loading condition), number of antennas, antenna orientation, type of sensing (e.g., monostatic, bistatic, and/or multi-static sensing), and type of waveform (e.g., frequency modulated continuous wave (FMCW) and/or OFDM) for the sensing entity.

In some examples, a sensing server (e.g., or sensing function) may send a configuration message to one or more sensing entities (e.g., RF sensing receivers and RF sensing transmitters). In one or more examples, the configuration message may include a configuration of all of the parameters within the capability report and may include a selection of the sensing entities.

In one or more examples, sensing entities (e.g., RF sensing receivers) may each send (e.g., report) measurement report to a sensing server (e.g., or a sensing function). Each measurement report may include information regarding anomaly detection based on the sensing entity's own observation, a variance of the distance measurements and the angular measurements, and/or a measurement for each observed path. In one or more examples, the sensing server (e.g., or sensing function) may fuse together all of the data from the measurement reports to determine whether there is a jamming scenario.

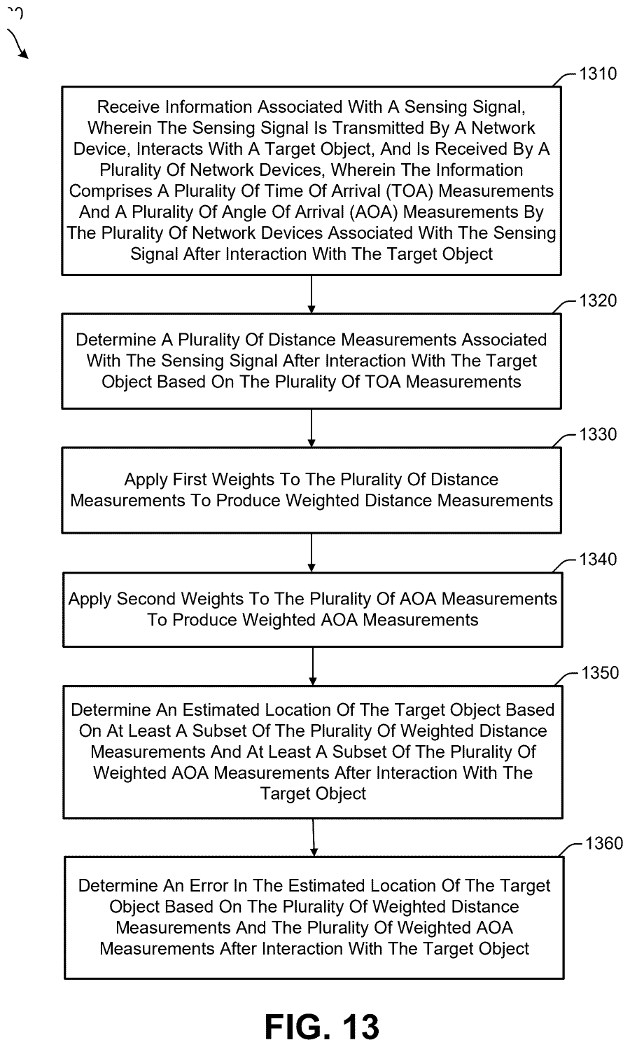

FIG. 13 is a flow chart illustrating an example of a process 1300 for wireless communications. The process 1300 can be performed by a network entity (e.g., network device 1020a of FIG. 10, network device 1020b of FIG. 10, network entity 1040 of FIG. 10, and/or a computing device or computing system 1400 of FIG. 14) or by a component or system (e.g., a chipset, one or more processors, one or more central processing units (CPUs), digital signal processors (DSPs), graphics processing units (GPUs), any combination thereof, and/or other type of processor(s), or other component or system) of the computing device. The operations of the process 1300 may be implemented as software components that are executed and run on one or more processors (e.g., processor 1410 of FIG. 14 or other processor(s)). Further, the transmission and reception of signals by the computing device in the process 1300 may be enabled, for example, by one or more antennas and/or one or more transceivers (e.g., wireless transceiver(s)).

At block 1310, the network entity (or component thereof) can receive information associated with a sensing signal. The sensing signal is transmitted by a network device (e.g., an RF sensing transmitter, such as network device 1010 of FIG. 10). After being transmitted by the network device, the sensing signal interacts with a target object (e.g., a vehicle, such as target 1030 of FIG. 10) and is received by a plurality of network devices (e.g., RF sensing receivers, such as network devices 1020a, 1020b of FIG. 10). In some cases, the information includes a plurality of TOA measurements and a plurality of AOA measurements by the plurality of network devices associated with the sensing signal after interaction with the target object. For example, the interaction with the target object may include a reflection of the sensing signal from the target object or an active manipulation of the sensing signal by the target object. In one illustrative example, the active manipulation can include manipulating the Doppler in the signal, such as by performing digital beamforming (e.g., to propagate the replayed signal in a direction towards a receiver in a known location) and producing a Doppler shift in the signal. In another example, the active manipulation can include manipulating the codes used in a replayed signal, resulting in a code phase of the replayed signal being ahead of that of the real sensing signal.

In some aspects, the network entity (or component thereof) may be a sensing function or a computing device implementing the sensing function. For instance, the sensing function may be implemented in a sensing server (e.g., network entity 1040 of FIG. 10) and/or in a network device (e.g., one of the network devices 1020a, 1020b of FIG. 10) of the plurality of network devices. In some examples, the network device of the plurality of network devices may be a receiver device (e.g., an RF sensing receiver, such as network devices 1020a, 1020b of FIG. 10). In some examples, the network device that transmits the sensing signal may be a transmitter device (e.g., an RF sensing transmitter, such as network device 1010 of FIG. 10). In one or more examples, the network device of the plurality of network devices may be located at a known first position, and the network device that transmits the sensing signal may be located at a known second position. In one or more examples, the first network device (e.g., an RF sensing receiver) of the plurality of network devices and at least one other network device (e.g., another RF sensing receiver, such as in a multi-static sensing scenario) of the plurality of network devices may be separated (or spread) spatially from each other around the target object.

At block 1320, the network entity (or component thereof) can determine a plurality of distance measurements associated with the sensing signal after interaction with the target object based on the plurality of TOA measurements.

At block 1330, the network entity (or component thereof) can apply first weights (e.g., weight w applied to a first parameter, such as distance measurements) to the plurality of distance measurements to produce weighted distance measurements. At block 1340, the network entity (or component thereof) can apply second weights (e.g., weight w applied to a first parameter, such as AOA measurements) to the plurality of AOA measurements to produce weighted AOA measurements. In one or more examples, the first weights and the second weights may be based on a signal to noise ratio (SNR) of the sensing signal after interaction with the target object

$$( e . g . , {w}_{{r}_{i}} = \frac{{σ}_{{r}_{i}}^{2}}{SNR ’} {σ}_{{r}_{i}}^{2} , {w}_{{θ}_{i}} = \frac{{σ}_{{θ}_{i}}^{2}}{SNR ’} {σ}_{{θ}_{i}}^{2} , {w}_{{φ}_{i}} = \frac{{σ}_{{φ}_{i}}^{2}}{S N R} , {σ}_{{φ}_{i}}^{2} , e t c . ) ,$$

an accuracy of the plurality of TOA measurements, and/or an accuracy of the plurality of AOA measurements.

At block 1350, the network entity (or component thereof) can determine an estimated location of the target object based on at least a subset of the plurality of weighted distance measurements and at least a subset of the plurality of weighted AOA measurements after interaction with the target object.

At block 1360, the network entity (or component thereof) can determine an error in the estimated location of the target object based on the plurality of weighted distance measurements and the plurality of weighted AOA measurements after interaction with the target object. In some aspects, the network entity may determine a jamming scenario is present based on the error in the estimated location of the target object being greater than an error threshold (e.g., a variance of a predetermined multiple of standard deviation). In some cases, the network entity may determine a jamming scenario is present based on determining a discrepancy in the plurality of AOA measurements. In some examples, the network entity may determine a jamming scenario is present based on a discrepancy in the plurality of distance measurements.

In some aspects, the network entity (or component thereof) can track the target (e.g., vehicle) over a period of time to observe a velocity of the target object and a Doppler of the target object. In one or more examples, the network entity (or component thereof) can determine a jamming scenario is present based on determining a discrepancy between the velocity of the target object and the Doppler of the target object over the period of time. However, jamming scenarios may not always be detected by monitoring for this discrepancy because Doppler shift is only associated with movement along the line between the RF sensing transmitter and the RF sensing receiver. If the movement is perpendicular to this line, there will be no Doppler shift present.

In some cases, the sensing signal includes multiple frequencies (e.g., in non-adjacent, or even far apart frequency bands, such as from seven to twenty-two Gigahertz), which can be used for combatting jamming. For instance, the multiple frequencies can allow for a network device (e.g., a RF sensing receiver) or a network entity (e.g., a sensing function) to be able to detect jamming because it can be difficult for a jammer to jam multiple frequencies in a consistent way. In some aspects, the sensing signal includes a pulse with suppressed ripples (e.g., low ripples). In some examples, the suppressed ripples can be achieved by using a larger bandwidth or a larger main lobe. In some cases, the pulse with suppressed ripples is a Gaussian pulse.

In some aspects, the sensing signal can be encoded (e.g., modulated) with a code with an auto-correlation function (e.g., a low autocorrelation function). In one or more examples, a Zadoff-Chu code may be employed for the code with an auto-correlation function (e.g., a low autocorrelation function). In some examples, the autocorrelation (e.g., low autocorrelation) may reduce the randomness in the codes.

In some cases, the computing device of process 1300 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1300 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1300 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1300 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a block diagram illustrating an example of a computing system 1400, which may be employed for the systems and techniques. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1400 includes at least one processing unit (CPU or processor) 1410 and connection 1405 that communicatively couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400.

Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1440 may also include one or more range sensors (e.g., LiDAR sensors, laser range finders, RF radars, ultrasonic sensors, and infrared (IR) sensors) configured to collect data and provide measurements to processor 1410, whereby processor 1410 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. A network entity for wireless communications, the network entity comprising: at least one memory; and at least one processor coupled to the at least one memory and configured to: receive information associated with a sensing signal, wherein the sensing signal is transmitted by a network device, interacts with a target object, and is received by a plurality of network devices, wherein the information comprises a plurality of time of arrival (TOA) measurements and a plurality of angle of arrival (AOA) measurements by the plurality of network devices associated with the sensing signal after interaction with the target object; determine a plurality of distance measurements associated with the sensing signal after interaction with the target object based on the plurality of TOA measurements; apply first weights to the plurality of distance measurements to produce a plurality of weighted distance measurements; apply second weights to the plurality of AOA measurements to produce a plurality of weighted AOA measurements; determine an estimated location of the target object based on at least a subset of the plurality of weighted distance measurements and at least a subset of the plurality of weighted AOA measurements after interaction with the target object; and determine an error in the estimated location of the target object based on the plurality of weighted distance measurements and the plurality of weighted AOA measurements after interaction with the target object.

Aspect 2. The network entity of Aspect 1, wherein the at least one processor is configured to determine a jamming scenario is present based on the error in the estimated location of the target object being greater than an error threshold.

Aspect 3. The network entity of any of Aspects 1 or 2, wherein the at least one processor is configured to track the target object over a period of time to observe a velocity of the target object and a Doppler of the target object.

Aspect 4. The network entity of Aspect 3, wherein the at least one processor is configured to determine a jamming scenario is present based on determining a discrepancy between the velocity of the target object and the Doppler of the target object over the period of time.

Aspect 5. The network entity of any of Aspects 1 to 4, wherein the at least one processor is configured to determine a jamming scenario is present based on determining a discrepancy in the plurality of AOA measurements.

Aspect 6. The network entity of any of Aspects 1 to 5, wherein the at least one processor is configured to determine a jamming scenario is present based on a discrepancy in the plurality of distance measurements.

Aspect 7. The network entity of any of Aspects 1 to 6, wherein the sensing signal comprises multiple frequencies.

Aspect 8. The network entity of any of Aspects 1 to 7, wherein the sensing signal comprises a pulse with suppressed ripples.

Aspect 9. The network entity of Aspect 8, wherein the pulse with suppressed ripples is a Gaussian pulse.

Aspect 10. The network entity of any of Aspects 1 to 9, wherein the sensing signal is encoded with a code with an auto-correlation function.

Aspect 11. The network entity of Aspect 10, wherein the code is a Zadoff-Chu code.

Aspect 12. The network entity of any of Aspects 10 or 11, wherein a phase of the code is randomized.

Aspect 13. The network entity of any of Aspects 1 to 12, wherein the first weights and the second weights are based on at least one of a signal to noise ratio (SNR) of the sensing signal after interaction with the target object, an accuracy of the plurality of TOA measurements, or an accuracy of the plurality of AOA measurements.

Aspect 14. The network entity of any of Aspects 1 to 13, wherein the network entity is a sensing function.

Aspect 15. The network entity of Aspect 14, wherein the sensing function is implemented in at least one of a sensing server or in the network device (or a different network device) of the plurality of network devices.

Aspect 16. The network entity of any of Aspects 1 to 15, wherein the interaction with the target object comprises reflection of the sensing signal from the target object or active manipulation of the sensing signal by the target object.

Aspect 17. A method for wireless communications at a network entity, the method comprising: receiving, by the network entity, information associated with a sensing signal, wherein the sensing signal is transmitted by a network device, interacts with a target object, and is received by a plurality of network devices, wherein the information comprises a plurality of time of arrival (TOA) measurements and a plurality of angle of arrival (AOA) measurements by the plurality of network devices associated with the sensing signal after interaction with the target object; determining, by the network entity, a plurality of distance measurements associated with the sensing signal after interaction with the target object based on the plurality of TOA measurements; applying, by the network entity, first weights to the plurality of distance measurements to produce a plurality of weighted distance measurements; applying, by the network entity, second weights to the plurality of AOA measurements to produce a plurality of weighted AOA measurements; determining, by the network entity, an estimated location of the target object based on at least a subset of the plurality of weighted distance measurements and at least a subset of the plurality of weighted AOA measurements after interaction with the target object; and determining, by the network entity, an error in the estimated location of the target object based on the plurality of weighted distance measurements and the plurality of weighted AOA measurements after interaction with the target object.

Aspect 18. The method of Aspect 17, further comprising determining, by the network entity, a jamming scenario is present based on the error in the estimated location of the target object being greater than an error threshold.

Aspect 19. The method of any of Aspects 17 or 18, further comprising tracking, by the network entity, the target object over a period of time to observe a velocity of the target object and a Doppler of the target object.

Aspect 20. The method of Aspect 19, further comprising determining, by the network entity, a jamming scenario is present based on determining a discrepancy between the velocity of the target object and the Doppler of the target object over the period of time.

Aspect 21. The method of any of Aspects 17 to 20, further comprising determining, by the network entity, a jamming scenario is present based on determining a discrepancy in the plurality of AOA measurements.

Aspect 22. The method of any of Aspects 17 to 21, further comprising determining, by the network entity, a jamming scenario is present based on a discrepancy in the plurality of distance measurements.

Aspect 23. The method of any of Aspects 17 to 22, wherein the sensing signal comprises multiple frequencies.

Aspect 24. The method of any of Aspects 17 to 23, wherein the sensing signal comprises a pulse with suppressed ripples.

Aspect 25. The method of Aspect 24, wherein the pulse with suppressed ripples is a Gaussian pulse.

Aspect 26. The method of any of Aspects 17 to 25, wherein the sensing signal is encoded with a code with an auto-correlation function.

Aspect 27. The method of Aspect 26, wherein the code is a Zadoff-Chu code.

Aspect 28. The method of any of Aspects 26 or 27, wherein a phase of the code is randomized.

Aspect 29. The method of any of Aspects 17 to 28, wherein the first weights and the second weights are based on at least one of a signal to noise ratio (SNR) of the sensing signal after interaction with the target object, an accuracy of the plurality of TOA measurements, or an accuracy of the plurality of AOA measurements.

Aspect 30. The method of any of Aspects 17 to 29, wherein the network entity is a sensing function.

Aspect 31. The method of Aspect 30, wherein the sensing function is implemented in at least one of a sensing server or in the network device (or a different network device) of the plurality of network devices.

Aspect 32. The method of any of Aspects 17 to 31, wherein the interaction with the target object comprises reflection of the sensing signal from the target object or active manipulation of the sensing signal by the target object.

Aspect 33. A non-transitory computer-readable medium having stored thereon instructions that, when executed by at least one processor, cause the at least one processor to perform operations according to any of Aspects 17 to 32.

Aspect 34. An apparatus for wireless communications, the apparatus including one or more means for performing operations according to any of Aspects 17 to 32.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A network entity for wireless communications, the network entity comprising:
at least one memory; and
at least one processor coupled to the at least one memory and configured to:
receive information associated with a sensing signal, wherein the sensing signal is transmitted by a network device, interacts with a target object, and is received by a plurality of network devices, wherein the information comprises a plurality of time of arrival (TOA) measurements and a plurality of angle of arrival (AOA) measurements by the plurality of network devices associated with the sensing signal after interaction with the target object;
determine a plurality of distance measurements associated with the sensing signal after interaction with the target object based on the plurality of TOA measurements;
apply first weights to the plurality of distance measurements to produce a plurality of weighted distance measurements;
apply second weights to the plurality of AOA measurements to produce a plurality of weighted AOA measurements;
determine an estimated location of the target object based on at least a subset of the plurality of weighted distance measurements and at least a subset of the plurality of weighted AOA measurements after interaction with the target object; and
determine an error in the estimated location of the target object based on the plurality of weighted distance measurements and the plurality of weighted AOA measurements after interaction with the target object.

2. The network entity of claim 1, wherein the at least one processor is configured to determine a jamming scenario is present based on the error in the estimated location of the target object being greater than an error threshold.

3. The network entity of claim 1, wherein the at least one processor is configured to track the target object over a period of time to observe a velocity of the target object and a Doppler of the target object.

4. The network entity of claim 3, wherein the at least one processor is configured to determine a jamming scenario is present based on determining a discrepancy between the velocity of the target object and the Doppler of the target object over the period of time.

5. The network entity of claim 1, wherein the at least one processor is configured to determine a jamming scenario is present based on determining a discrepancy in the plurality of AOA measurements.

6. The network entity of claim 1, wherein the at least one processor is configured to determine a jamming scenario is present based on a discrepancy in the plurality of distance measurements.

7. The network entity of claim 1, wherein the sensing signal comprises multiple frequencies.

8. The network entity of claim 1, wherein the sensing signal comprises a pulse with suppressed ripples.

9. The network entity of claim 8, wherein the pulse with suppressed ripples is a Gaussian pulse.

10. The network entity of claim 1, wherein the sensing signal is encoded with a code with an auto-correlation function.

11. The network entity of claim 10, wherein the code is a Zadoff-Chu code.

12. The network entity of claim 10, wherein a phase of the code is randomized.

13. The network entity of claim 1, wherein the first weights and the second weights are based on at least one of a signal to noise ratio (SNR) of the sensing signal after interaction with the target object, an accuracy of the plurality of TOA measurements, or an accuracy of the plurality of AOA measurements.

14. The network entity of claim 1, wherein the network entity is a sensing function.

15. The network entity of claim 14, wherein the sensing function is implemented in at least one of a sensing server or in the network device of the plurality of network devices.

16. The network entity of claim 1, wherein the interaction with the target object comprises reflection of the sensing signal from the target object or active manipulation of the sensing signal by the target object.

17. The network entity of claim 1, wherein the network device and at least one other first network device are separated spatially from each other around the target object.

18. A method for wireless communications at a network entity, the method comprising:
receiving, by the network entity, information associated with a sensing signal, wherein the sensing signal is transmitted by a network device, interacts with a target object, and is received by a plurality of network devices, wherein the information comprises a plurality of time of arrival (TOA) measurements and a plurality of angle of arrival (AOA) measurements by the plurality of network devices associated with the sensing signal after interaction with the target object;
determining, by the network entity, a plurality of distance measurements associated with the sensing signal after interaction with the target object based on the plurality of TOA measurements;
applying, by the network entity, first weights to the plurality of distance measurements to produce a plurality of weighted distance measurements;
applying, by the network entity, second weights to the plurality of AOA measurements to produce a plurality of weighted AOA measurements;
determining, by the network entity, an estimated location of the target object based on at least a subset of the plurality of weighted distance measurements and at least a subset of the plurality of weighted AOA measurements after interaction with the target object; and
determining, by the network entity, an error in the estimated location of the target object based on the plurality of weighted distance measurements and the plurality of weighted AOA measurements after interaction with the target object.

19. The method of claim 18, further comprising determining, by the network entity, a jamming scenario is present based on the error in the estimated location of the target object being greater than an error threshold.

20. The method of claim 18, further comprising determining, by the network entity, a jamming scenario is present based on determining a discrepancy between a velocity of the target object and a Doppler of the target object over a period of time.
